(19) United States
(12) Patent Application Publication
(10) Pub. No.: US 2018/0046490 A1
(43) Pub. Date: Feb. 15, 2018

(54) MOVING CONTROL APPARATUS AND MOVING CONTROL METHOD

(71) Applicant: FUJITSU LIMITED, Kawasaki-shi (JP)

(72) Inventor: Koichi ONOUE, Kawasaki (JP)

(73) Assignee: FUJITSU LIMITED, Kawasaki-shi (JP)

(21) Appl. No.: 15/666,696

(22) Filed: Aug. 2, 2017

(30) Foreign Application Priority Data
Aug. 15, 2016 (JP) 2016-159343

(51) Int. Cl. G06F 9/455

(52) U.S. Cl. CPC G06F 9/45558; G06F 2009/45583

(57) ABSTRACT

A moving control method performed by a computer, includes: generating a first-conditional expression for a relationship between a first variable for a physical machine on which each of the virtual machines is disposed and a second variable for a movement status of each of the virtual machines, based on the first variable, and the second variable; generating a second-conditional expression for a relationship between the second variable and a third variable, based on the second variable, and a third variable for time taken to move the virtual machines; calculating values of the first variable, the second variable, and the third variable where the third variable is smallest, based on the first-conditional expression, the second-conditional expression; and performing an instruction to move each of the virtual machines, based on the values of the first variable, the second variable, and the third variable where the third variable is smallest.

### CROSS-REFERENCE TO RELATED APPLICATION

This application is based upon and claims the benefit of priority of the prior Japanese Patent Application No. 2016-159343, filed on Aug. 15, 2016, the entire contents of which are incorporated herein by reference.

### FIELD

The embodiment discussed herein is related to a computer-readable recording medium storing a moving control program, a moving control apparatus, and a moving control method.

### BACKGROUND

Recently, research for a virtualization technology of integrating a plurality of virtual machines (VM) into one physical machine proceeds with improving the performance of a physical machine. In the virtualization technology, for example, virtualization software (also referred to as a hypervisor below) allocates physical resources of a physical machine to a plurality of virtual machines, and an application program (also referred to as an application below) installed on each of the virtual machines allows a service to be provided.

In such a virtual machine, a manager that manages virtual machines (simply also referred to as a manager below), if desirable, moves the virtual machine between physical machines (this action is also referred to as migration below). Thus, the manager can perform relocation of a virtual machine, for example, in accordance with a use situation of a service by a user. Accordingly, the manager can realize effective utilization and the like of physical resources of a physical machine (for example, see Japanese Laid-open Patent Publication No. 2010-244524 and Japanese Laid-open Patent Publication No. 2015-011569).

In such a case of moving a virtual machine, the manager moves a virtual machine to a physical machine in which the residual physical resource remains, for example, among physical machines on which each virtual machine operates. However, in this case, a physical machine to which a virtual machine is allowed to be moved is limited to a physical machine in which the residual physical resource remains in the current state. Thus, after a virtual machine is moved, deployment of each virtual machine may be not optimum deployment for a virtual machine, from a viewpoint of effectively using physical resources of a physical machine.

On the contrary, the manager, for example, utilizes a mathematical programming method such as an optimization solver, and thus it is possible to determine deployment of virtual machines (also referred to as optimized deployment) which allows physical resources of a physical machine to be used most effectively, in advance. However, regarding deployment of virtual machines, which is calculated by a mathematical programming method, a situation of the remaining physical resources of each physical machine when each virtual machine moves, or a difference of time taken to move each virtual machine may be not considered. Thus, it may be difficult that the manager specifies a movement order of virtual machines for relocating the virtual machines in optimum deployment.

### SUMMARY

According to an aspect of the embodiments, a moving control method which is performed by a computer, the method includes: generating a first conditional expression for indicating a relationship between a first variable and a second variable, based on duration information, estimation time information, the first variable, and the second variable, the duration information for indicating time taken to move each of a plurality of virtual machines which move between a plurality of physical machines, the estimation time information for indicating estimation time taken to move the plurality of virtual machines, the first variable for indicating a physical machine on which each of the plurality of virtual machines is disposed, and the second variable for indicating a movement status of each of the plurality of virtual machines; generating a second conditional expression for indicating a relationship between the second variable and a third variable, based on the estimation time information, the second variable, and a third variable for indicating time taken to move the plurality of virtual machines; generating a third conditional expression for indicating a condition of resource information of a virtual machine moving to a physical machine as a moving destination, based on movement information, the estimation time information, resource information of each of the plurality of physical machines, resource information of each of the plurality of virtual machines, the first variable, and the second variable, the movement information for indicating physical machines as a moving source and a moving destination of each of the plurality of virtual machines; generating a fourth conditional expression for indicating a condition of movable number information corresponding to a moving route when each of the plurality of virtual machines moves, based on the movement information, the duration information, the estimation time information, the movable number information, and the second variable, the movable number information for indicating the number of virtual machines which are movable in parallel to each of the plurality of moving routes between the plurality of physical machines; generating a fifth conditional expression for indicating that each of the plurality of virtual machines is disposed on any of the plurality of physical machines, based on the movement information, the estimation time information, and the first variable; generating a sixth conditional expression for indicating that each of the plurality of virtual machines is disposed on a physical machine as the moving source during a period from when moving from the physical machine as the moving source is started until moving from the physical machine as the moving source is completed, and that each of the plurality of virtual machines is disposed on a physical machine as the moving destination in a period indicated by the estimation time information, based on the movement information, the duration information, the estimation time information, and the first variable; calculating values of the first variable, the second variable, and the third variable in a case where the third variable is smallest, based on the first conditional expression, the second conditional expression, the third conditional expression, the fourth conditional expression, the fifth conditional expression, and the sixth conditional expression; and performing an instruction to move each of the plurality of virtual machines, based on the values of the first variable, the second variable, and the third variable in a case where the third variable is smallest, regarding moving of the plurality of virtual machines between the plurality of physical machines.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overall configuration of an information processing system;

FIG. 2 is a diagram illustrating a specific example of a virtual machine disposed in a physical machine;

FIG. 3 is a diagram illustrating a hardware configuration of an information processing apparatus;

FIG. 4 is a functional block diagram of the information processing apparatus in FIG. 3;

FIG. 5 is a flowchart illustrating an outline of moving control processing in a first embodiment;

FIG. 6 is a flowchart illustrating the outline of the moving control processing in the first embodiment;

FIG. 7 is a flowchart illustrating details of the moving control processing in the first embodiment;

FIG. 8 is a flowchart illustrating the details of the moving control processing in the first embodiment;

FIG. 9 is a flowchart illustrating the details of the moving control processing in the first embodiment;

FIG. 10 is a flowchart illustrating the details of the moving control processing in the first embodiment;

FIG. 11 is a flowchart illustrating the details of the moving control processing in the first embodiment;

FIG. 12 is a flowchart illustrating the details of the moving control processing in the first embodiment;

FIG. 13 is a flowchart illustrating the details of the moving control processing in the first embodiment;

FIG. 14 is a flowchart illustrating the details of the moving control processing in the first embodiment;

FIG. 15A is a diagram illustrating a specific example of deployment information, and FIG. 15B is a diagram illustrating a specific example of status information;

FIG. 16A is a diagram illustrating a specific example of deployment information, and FIG. 16B is a diagram illustrating a specific example of status information;

FIG. 17A is a diagram illustrating a specific example of deployment information, and FIG. 17B is a diagram illustrating a specific example of status information;

FIG. 18 is a diagram illustrating a specific example of total duration information;

FIG. 19 is a diagram illustrating a specific example of estimation time information;

FIG. 20 is a diagram illustrating a specific example of duration information;

FIG. 21 is a diagram illustrating a specific example of movement information;

FIG. 22A is a diagram illustrating a specific example of physical resource information, and FIG. 22B is a diagram illustrating a specific example of virtual resource information;

FIG. 23 is a diagram illustrating a specific example in a case where a network device is provided on a plurality of moving routes;

FIG. 24 is a diagram illustrating a specific example of network information;

FIG. 25 is a diagram illustrating a specific example of movable number information;

FIG. 26 is a diagram illustrating a specific example of constraint conditional expression information;

FIG. 27 is a diagram illustrating a specific example of objective functional expression information; and

FIG. 28 is a diagram illustrating a specific example of result information.

### DESCRIPTION OF EMBODIMENT

Configuration of Information Processing System

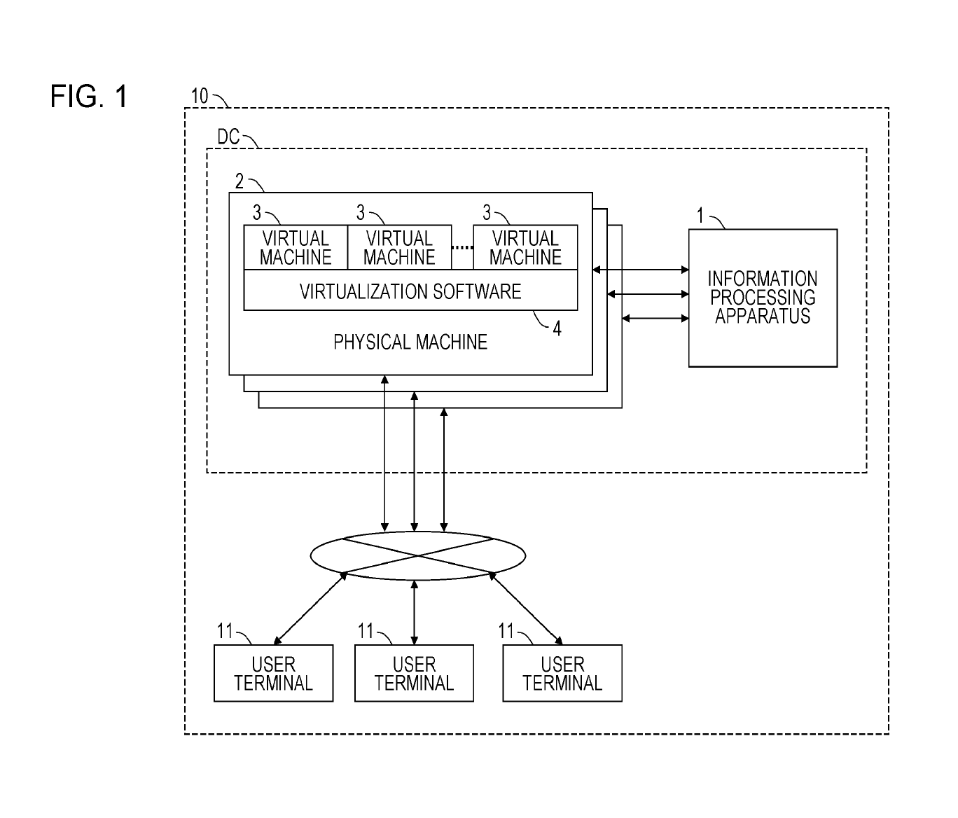

FIG. 1 is a diagram illustrating an overall configuration of an information processing system 10. The information processing system 10 illustrated in FIG. 1 is a business system that provides a service for a user. In the information processing system 10 illustrated in FIG. 1, an information processing apparatus 1 and a physical machine 2 are provided in a data center DC. The user terminal 11 may access the data center DC through a network such as the Internet and/or an intranet.

The physical machine 2 is configured, for example, by a plurality of physical machines. Each of the physical machines includes a central computing unit (CPU), a memory (DRAM: dynamic random access memory), and a large-capacity memory such as a hard disk drive (HDD). Physical resources of the physical machine 2 are assigned to a plurality of virtual machines 3.

The information processing apparatus 1 can access the virtual machine 3 so as to manage the virtual machine 3 created in the physical machine 2. The information processing apparatus 1 may be created by the virtual machine 3, for example,

In the virtual machine 3, an infrastructure may be provided to a user via a network (also referred to as a cloud service below).

The cloud service is a service for providing the foundation for constructing and operating a computer system, that is, an infrastructure such as the virtual machine 3 or the network, via a network. For example, a user selects the specifications desired for the virtual machine 3, such as a clock frequency of the CPU, the capacity of the memory, capacity of a hard disk, and a communication bandwidth of a network through a user terminal 11. The user concludes a cloud service utilization contract regarding the selected specifications. In addition, for example, the user can monitor a running status of the virtual machine 3 or operate the virtual machine 3 through the user terminal 11.

A virtualization software 4 is base software of allocating a CPU, a memory, a hard disk, and a network of the physical machine 2 in accordance with an instruction from the information processing apparatus 1, so as to operate the virtual machine 3. The virtualization software 4 operates in the physical machine 2, for example. The virtualization software 4 moves the virtual machine 3 between the physical machines 2, for example.

Specific Example of Virtual Machine Disposed in Physical Machine

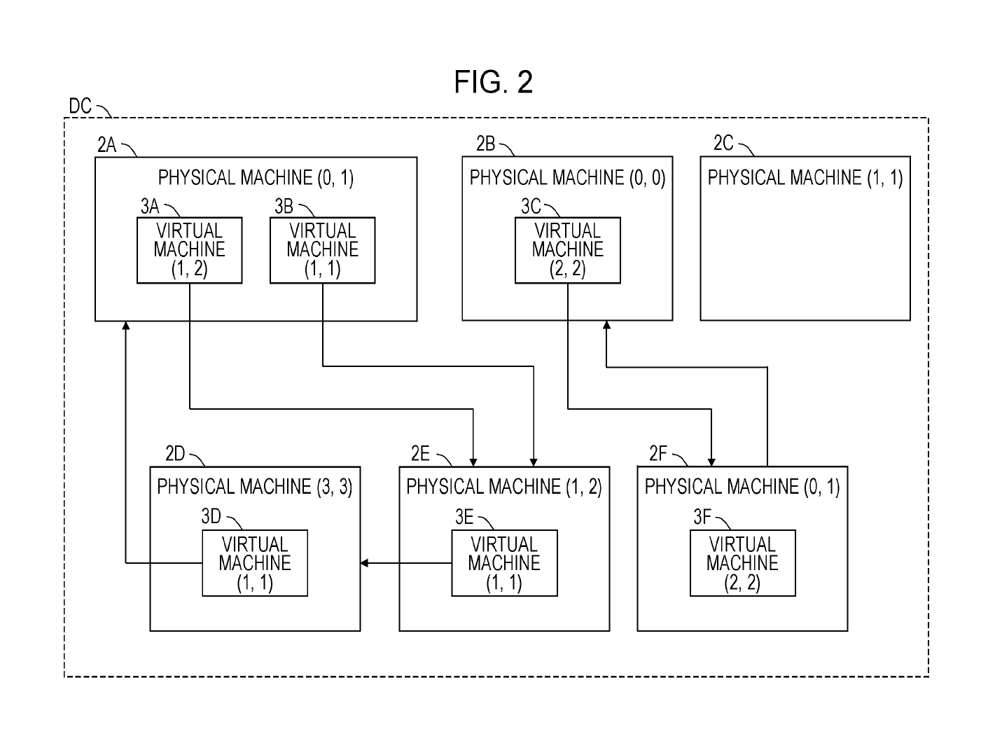

Next, a specific example of the virtual machine 3 disposed in the physical machine 2 will be described. FIG. 2 is a diagram illustrating a specific example of the virtual machine 3 disposed in the physical machine 2.

In the example illustrated in FIG. 2, physical machines 2A, 2B, 2C, 2D, 2E, and 2F are disposed in the data center DC. A virtual machine 3A and a virtual machine 3B are disposed in the physical machine 2A, and a virtual machine 3C is disposed in the physical machine 2B. Virtual machines 3D, 3E, and 3F are disposed in the physical machines 2D, 2E, and 2F, respectively.

In the example illustrated in FIG. 2, “physical machine (0, 1)” in the physical machine 2A indicates that available capacity of a disk is “0 (GB)” and available capacity of a memory is “1 (GB)” in the physical machine 2A. In the example illustrated in FIG. 2, “virtual machine (1, 2)” in the virtual machine 3A indicates that use capacity of a disk desired for causing the virtual machine 3A to operate is “1 (GB)” and use capacity of a memory is “2 (GB)”. Descriptions of other physical machines 2 and other virtual machines 3 in FIG. 2 will be not repeated.

In the virtual machine 3 as illustrated in FIG. 2, if desirable, a manager moves the virtual machine 3 between the physical machines 2. Thus, the manager can perform relocation of the virtual machines 3 in accordance with a use situation of a service by a user, for example. Accordingly, the manager can realize effective utilization and the like of the physical resources of the physical machine 2.

Specifically, in a case where the manager moves the virtual machine 3, the manager moves the virtual machine 3 to a physical machine 2 having the remaining physical resources among the physical machines 2 on which the virtual machine 3 runs. In this case, a physical machine 2 to which moving of the virtual machine 3 is allowed is limited to a physical machine 2 having the remaining physical resources in the current state. Thus, after the virtual machine 3 moves, deployment of the virtual machines 3 may be not optimum deployment for the virtual machines 3, from a viewpoint of effectively using physical resources of the physical machine 2.

By the way, the manager may utilize, for example, a mathematical programming method (for example, optimization solver). Thus, as indicated by each arrow in FIG. 2, the manager can calculate optimum deployment for the virtual machines 3, which allows the most efficient use of the physical resources of the physical machine 2. However, regarding deployment of the virtual machines 3, which is calculated by the mathematical programming method, a situation of the remaining physical resources of each physical machine 2 when each of the virtual machine 3 moves may be not considered.

Specifically, in the example illustrated in FIG. 2, the manager is to move the virtual machine 3A and the virtual machine 3B to the physical machine 2E from the physical machine 2A. The sum of use capacity of disks of the virtual machine 3A and the virtual machine 3B is “2 (GB)”. The sum of use capacity of memories of the virtual machine 3A and the virtual machine 3B is “3 (GB)”. Thus, “2 (GB)” or larger of the available capacity of a disk and “3 (GB)” or larger of the available capacity of a memory in the physical machine 2E are desired for moving the virtual machine 3A and the virtual machine 3B to the physical machine 2E from the physical machine 2A.

However, in the example illustrated in FIG. 2, the available capacity of the disk is “1 (GB)” and the available capacity of the memory is “2 (GB)” in the physical machine 2E. Thus, it is not possible to simultaneously move the virtual machine 3A and the virtual machine 3B to the physical machine 2E, as illustrated in FIG. 2. That is, a virtual machine 3 of which immediate moving to the physical machine 2E is not allowed among the virtual machine 3A and the virtual machine 3B can move only after the virtual machine 3E moves to the physical machine 2D from the physical machine 2E.

In the example illustrated in FIG. 2, the manager is to move the virtual machine 3C to the physical machine 2F from the physical machine 2B and is to move the virtual machine 3F to the physical machine 2F from the physical machine 2B. Use capacity of a disk of the virtual machine 3C is “2 (GB)” and use capacity of a memory of the virtual machine 3C is “2 (GB)”. The sum of use capacity of a disk of the virtual machine 3F is “2 (GB)” and the sum of use capacity of a memory of the virtual machine 3F is “2 (GB)”. Thus, “2 (GB)” or larger of the available capacity of a disk and “2 (GB)” or larger of the available capacity of a memory in the physical machine 2F are desired for moving the virtual machine 3C to the physical machine 2F from the physical machine 2B. “2 (GB)” or larger of the available capacity of a disk and “2 (GB)” or larger of the available capacity of a memory in the physical machine 2B are desired for moving the virtual machine 3F to the physical machine 2B from the physical machine 2F.

However, in the example illustrated in FIG. 2, the available capacity of the disk is “0 (GB)” and the available capacity of the memory is “1 (GB)” in the physical machine 2F. In addition, in the example illustrated in FIG. 2, the available capacity of the disk is “0 (GB)” and the available capacity of the memory is “0 (GB)” in the physical machine 2B. Thus, it is not possible to simultaneously move the virtual machine 3C and the virtual machine 3F to physical machines 2 as moving destinations, respectively.

In the example illustrated in FIG. 2, the manager is to move the virtual machine 3D to the physical machine 2A from the physical machine 2D. Use capacity of a disk of the virtual machine 3D is “1 (GB)” and use capacity of a memory of the virtual machine 3D is “1 (GB)”. Thus, “1 (GB)” or larger of the available capacity of a disk and “1 (GB)” or larger of the available capacity of a memory in the physical machine 2A are desired for moving the virtual machine 3D to the physical machine 2A from the physical machine 2D.

However, in the example illustrated in FIG. 2, the available capacity of the disk is “0 (GB)” and the available capacity of the memory is “1 (GB)” in the physical machine 2A. Thus, it is not possible to move the virtual machine 3D to the physical machine 2A. That is, in this case, the virtual machine 3D is desired to move to the physical machine 2A after the virtual machine 3A or the virtual machine 3B moves to the physical machine 2E from the physical machine 2A.

Thus, even in a case where the optimum deployment is calculated by using the mathematical programming method, it may be difficult that the manager specifies a movement order of virtual machines 3 for relocating the virtual machines 3 in the optimum deployment.

A time taken to cause each of the virtual machines 3 to move between physical machines 2 is not fixed. Thus, the manager preferably specifies a movement order for the virtual machines 3 in consideration of a difference between times taken to move the virtual machines 3, in order to reduce the total time taken to move all of the virtual machines 3.

Moving the virtual machines 3 is to be performed parallel with each other as many as possible, in order to reduce the total time taken to move all of the virtual machines 3. Thus, even in a case where a movable virtual machine 3 is provided, a start of moving the virtual machine 3 is delayed, and thus it may be possible to reduce the total time taken to move all of the virtual machines 3. Accordingly, the manager preferably determines a moving start time of each of the virtual machines 3 in addition to the movement order for the virtual machines 3, in consideration of a case where a movable virtual machine 3 is not immediately moved.

In the information processing apparatus 1 in the embodiment, when the optimum deployment of each of the virtual machines 3 is calculated by the mathematical programming method, information indicating transition of a physical machine 2 in which each of the virtual machines 3 is disposed is considered.

Specifically, the information processing apparatus 1 in the embodiment acquires information indicating physical machines 2 as a moving source and a moving destination of each of a plurality of virtual machines 3 which move between a plurality of physical machines 2 (also referred to as movement information below), and information indicating a time which is taken to move each of the plurality of virtual machines 3 (also referred to as duration information below). The information processing apparatus 1 acquires information indicating an estimation time which is taken to all of the plurality of virtual machines 3 (also referred to as estimation time information below), resource information of each of the plurality of physical machines 2 (also referred to as physical resource information below), and resource information of each of the plurality of virtual machines 3 (also referred to as virtual resource information below). Further, the information processing apparatus 1 acquires information indicating the number of virtual machines 3 which allow moving on a moving route in parallel with each other between the plurality of physical machines 2 (also referred to as movable number information below).

The information processing apparatus 1 generates an expression (also referred to as a first conditional expression below) indicating a relationship between a first variable and a second variable, based on duration information, estimation time information, a variable indicating a physical machine 2 in which each of the plurality of virtual machines 3 is disposed (also referred to as the first variable or deployment information below), and a variable indicating a movement status of each of the plurality of virtual machines 3 (also referred to as the second variable or status information below).

The information processing apparatus 1 generates an expression (also referred to as a second conditional expression below) indicating a relationship between the second variable and a third variable, based on the estimation time information, the second variable, a variable indicating a time which is taken to move all of the plurality of virtual machines 3 (also referred to as the third variable or total duration information below).

The information processing apparatus 1 generates an expression (also referred to as a third conditional expression below) indicating a condition of virtual resource information of a virtual machine 3 which moves to a physical machine 2 as the moving destination, based on the movement information, the estimation time information, the physical resource information, the virtual resource information, the first variable, and the second variable.

The information processing apparatus 1 generates an expression (also referred to as a fourth conditional expression below) indicating a condition of movable number information which corresponds to a moving route when each of the plurality of virtual machines 3 moves, based on the movement information, the duration information, the estimation time information, the movable number information, and the second variable.

The information processing apparatus 1 generates an expression (referred to as a fifth conditional expression below) indicating that each of the plurality of virtual machines 3 is disposed in any of the plurality of physical machines 2, based on the movement information, the estimation time information, and the first variable.

The information processing apparatus 1 generates an expression (also referred to as a sixth conditional expression below) based on the movement information, the duration information, the estimation time information, and the first variable. The sixth conditional expression indicates that each of the plurality of virtual machines 3 is disposed in a physical machine 2 as a moving source for a period from when moving from the physical machine 2 as the moving source starts until moving from the physical machine 2 as the moving source is completed, and indicates that each of the plurality of virtual machines 3 is disposed in a physical machine 2 as a moving destination in a time indicated by the estimation time information.

Then, the information processing apparatus 1 calculates the first variable, the second variable, and the third variable in a case where the third variable is smallest, based on the first conditional expression, the second conditional expression, the third conditional expression, the fourth conditional expression, the fifth conditional expression, and the sixth conditional expression, which have been generated.

That is, the information processing apparatus 1 creates an expression of allowing calculation of total duration information which is a time taken to move all of the virtual machines 3 and calculation of deployment information indicating a physical machine 2 in which each of the virtual machines 3 is disposed, and status information indicating transition of a physical machine 2 in which each of the virtual machines 3 is disposed.

Thus, the information processing apparatus 1 can specify a movement order for the virtual machines 3 and a moving start time of each of the virtual machines 3, which are used for performing relocation of the virtual machines 3 in accordance with the optimum deployment of the virtual machines 3 for a period as short as possible.

Hardware Configuration of Information Processing Apparatus

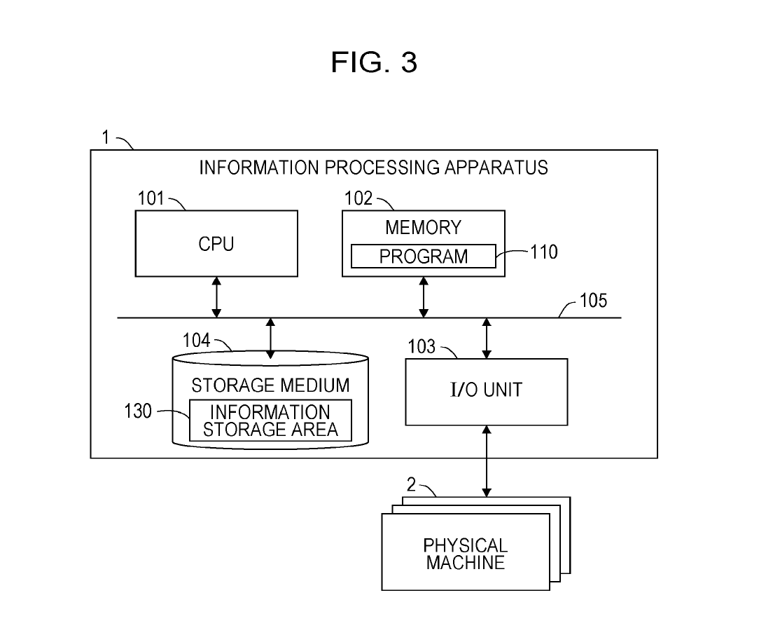

Next, a hardware configuration of the information processing apparatus 1 will be described. FIG. 3 is a diagram illustrating a hardware configuration of the information processing apparatus 1.

The information processing apparatus 1 includes a CPU 101 which is a processor, a memory 102, an external interface (I/O unit) 103, and a storage medium (storage) 104. The above members are coupled to each other through a bus 105.

The storage medium 104 stores a program 110 for performing processing (also referred to as moving control processing below) of controlling moving of each of the virtual machine 3. The program 110 is stored in a program storage area (not illustrated) of the storage medium 104.

As illustrated in FIG. 3, when the CPU 101 executes the program 110, the CPU 101 loads the program 110 on the memory 102 from the storage medium 104, and performs moving control processing in cooperation with the program 110.

The storage medium 104 includes an information storage area 130 (also referred to as a storage section 130 below) in which information used when the moving control processing is performed is stored, for example. The external interface 103 communicates with the physical machine 2.

Software Configuration of Information Processing Apparatus

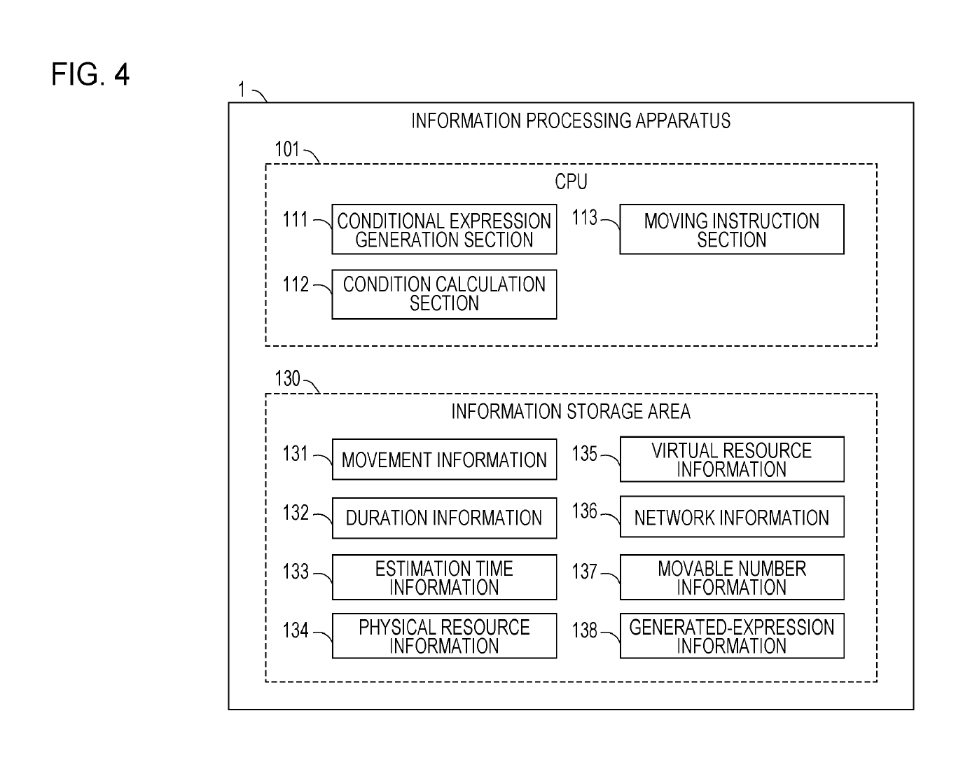

Next, a software configuration of the information processing apparatus 1 will be described. FIG. 4 is a functional block diagram illustrating the information processing apparatus 1 in FIG. 3. The CPU 101 cooperates with the program 110 and thus operates as a conditional expression generation section 111, a condition calculation section 112, and a moving instruction section 113.

As illustrated in FIG. 4, movement information 131, duration information 132, estimation time information 133, physical resource information 134, and virtual resource information 135 are stored in the information storage area 130. Network information 136, movable number information 137, and generated-expression information 138 are further stored in the information storage area 130.

The conditional expression generation section 111 acquires the movement information 131, the duration information 132, the estimation time information 133, the physical resource information 134, the virtual resource information 135, the network information 136, and the movable number information 137 which have been stored in the information storage area 130. The conditional expression generation section 111 generates the first conditional expression, the second conditional expression, the third conditional expression, the fourth conditional expression, the fifth conditional expression, and the sixth conditional expression, based on the acquired movement information 131 and the like. Then, the conditional expression generation section 111 stores the generated first conditional expression and the like in the information storage area 130, as the generated-expression information 138.

The condition calculation section 112 calculates each of deployment information 141 when total duration information 143 is smallest, status information 142, and the total duration information 143, based on the first conditional expression, the second conditional expression, the third conditional expression, the fourth conditional expression, the fifth conditional expression, and the sixth conditional expression which have been generated by the conditional expression generation section 111.

A business operator may store an expression (referred to as an objective functional expression below) indicating that the total duration information 143 has the smallest value, in the information storage area 130 in advance. The condition calculation section 112 may calculate deployment information 141, status information 142, and total duration information 143 which satisfy the objective functional expression stored in the information storage area 130, based on the expressions of the first conditional expression and the like.

The moving instruction section 113 determines a movement order for virtual machines 3 and a moving start time of each of the virtual machines 3, with reference to the deployment information 141, the status information 142, and the total duration information 143 which have been calculated by the condition calculation section 112. The moving instruction section 113 performs an instruction to move a virtual machine 3 in accordance with the movement order and the moving start time which have been determined. Specifically, for example, the moving instruction section 113 instructs the virtualization software 4 running on each physical machine 2 to move a virtual machine.

Outline of First Embodiment

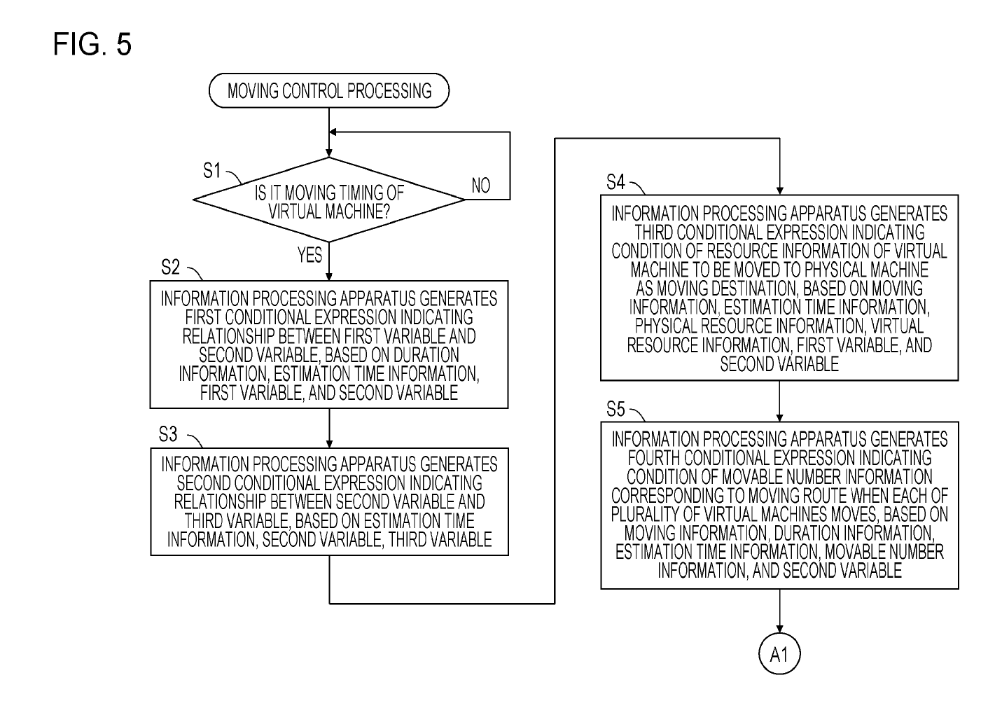

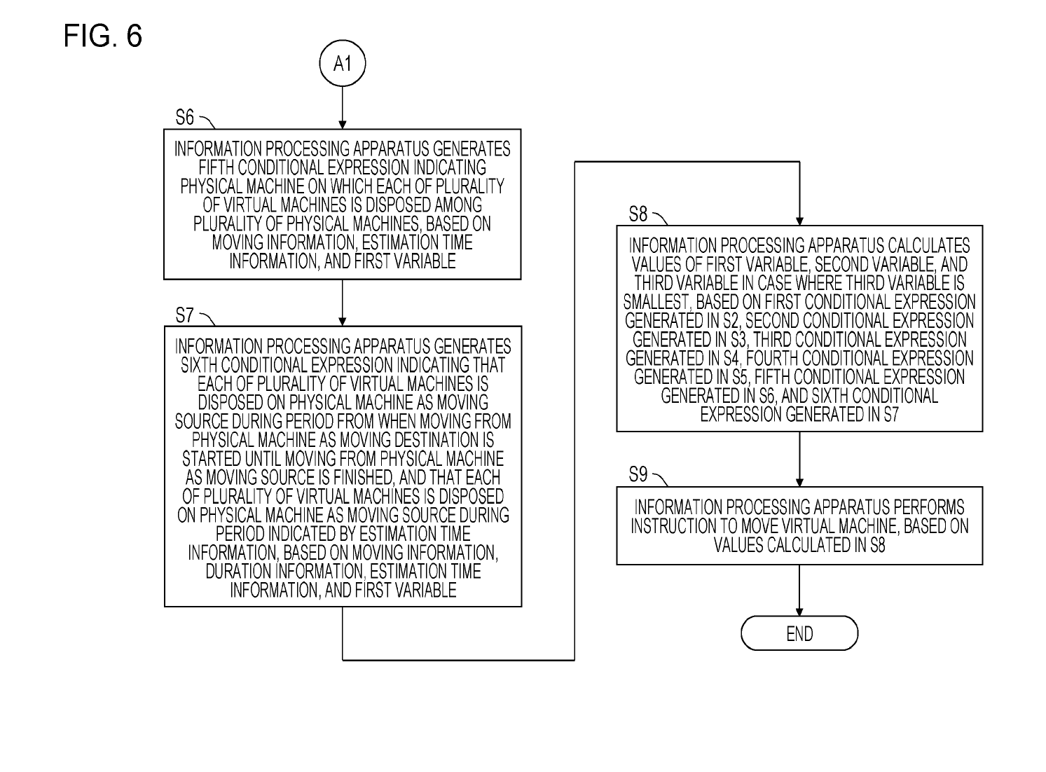

Next, an outline of the first embodiment will be described. FIGS. 5 and 6 are flowcharts illustrating an outline of the moving control processing in the first embodiment.

As illustrated in FIG. 5, the conditional expression generation section 111 of the information processing apparatus 1 waits for a moving timing of a virtual machine 3 (NO in S1). The moving timing of a virtual machine 3 may be, for example, a timing at which the manager determines that relocation of the virtual machine 3 is performed. Specifically, the moving timing of a virtual machine 3 may be a timing at which a physical machine 2 having a use rate of physical resources, which is more than a predetermined threshold is provided among physical machines 2 in which virtual machines 3 are disposed, and thus the manager determines to perform relocation of the virtual machine 3.

In a case where it is the moving timing of a virtual machine 3 (YES in S1), the conditional expression generation section 111 generates the first conditional expression indicating a relationship between deployment information 141 and status information 142, based on duration information 132, estimation time information 133, the deployment information 141, and the status information 142 (S2).

In this case, the conditional expression generation section 111 generates the second conditional expression indicating a relationship between the status information 142 and total duration information 143, based on the estimation time information 133, the status information 142, and the total duration information 143 (S3). In this case, the conditional expression generation section 111 generates the third conditional expression indicating a condition of virtual resource information 135 of a virtual machine 3 which moves to a physical machine 2 as a moving destination, based on movement information 131, the estimation time information 133, physical resource information 134, the virtual resource information 135, the deployment information 141, and the status information 142 (S4).

In this case, the conditional expression generation section 111 generates the fourth conditional expression indicating a condition of movable number information 137 corresponding to a moving route when each of a plurality of virtual machines 3 moves, based on the movement information 131, the duration information 132, the estimation time information 133, the movable number information 137, and the status information 142 (S5). In this case, the conditional expression generation section 111 generates the fifth conditional expression indicating that each of the plurality of virtual machines 3 is disposed in any of a plurality of physical machines 2, based on the movement information 131, the estimation time information 133, and the deployment information 141 (S6).

In this case, the conditional expression generation section 111 generates the sixth conditional expression, based on the movement information 131, the duration information 132, the estimation time information 133, and the deployment information 141 (S7). The sixth conditional expression includes an expression indicating that each of the plurality of virtual machines 3 is disposed in a physical machine 2 as a moving source for a period from when moving from the physical machine 2 as the moving source starts until moving from the physical machine 2 as the moving source is completed. The sixth conditional expression includes an expression indicating that each of the plurality of virtual machines 3 is disposed in a physical machine 2 as a moving destination in a time indicated by the estimation time information 133.

That is, the conditional expression generation section 111 performs the processes of S2 to S7 so as to create an expression of allowing calculation of the total duration information 143 which is time taken to move all of the virtual machines 3 and allowing calculation of the deployment information 141 and the status information 142.

The condition calculation section 112 of the information processing apparatus 1 calculates each of deployment information 141, status information 142, and total duration information 143 in a case where the total duration information 143 has the smallest value, based on the first conditional expression, the second conditional expression, the third conditional expression, the fourth conditional expression, the fifth conditional expression, and the sixth conditional expression which have been generated by the conditional expression generation section 111 in the processes of S2 and the like (S8).

Then, the moving instruction section 113 of the information processing apparatus 1 performs an instruction to move each of the plurality of virtual machines 3, based on the value calculated in the process of S8 (S9).

Thus, the information processing apparatus 1 can perform relocation of virtual machines 3 in accordance with the optimum deployment of the virtual machines 3, for a period as short as possible.

Details of First Embodiment

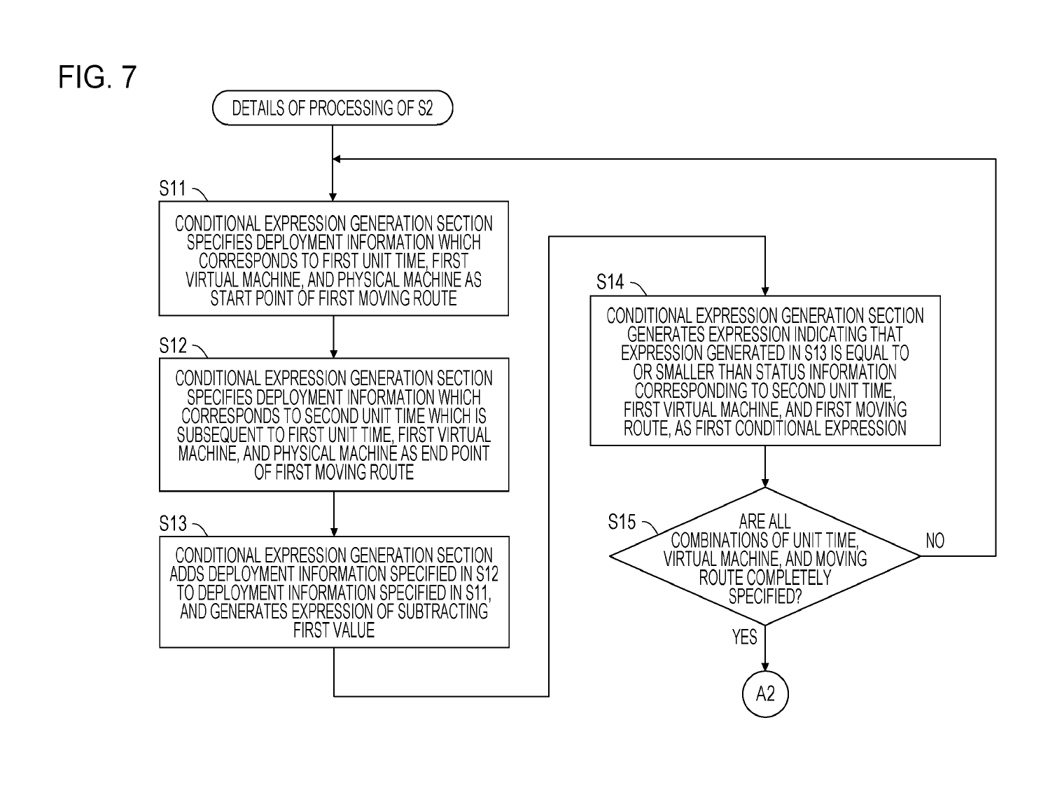

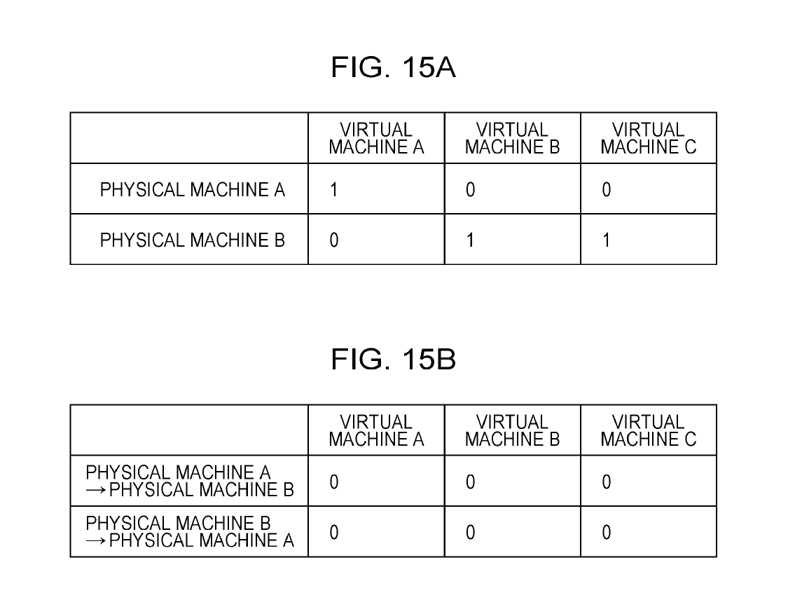

Next, details of the first embodiment will be described. FIGS. 7 to 14 are flowcharts illustrating details of the moving control processing in the first embodiment. FIGS. 15A to 28 are diagrams illustrating the details of the moving control processing in the first embodiment. The moving control processing in FIGS. 7 to 14 will be described with reference to FIGS. 15A to 28.

Deployment Information and Status Information

Firstly, deployment information 141 and status information 142 will be described. A case where a virtual machine 3A, a virtual machine 3B, and a virtual machine 3C move between a physical machine 2A and a physical machine 2B will be described below as an example. The physical machine 2A and the physical machine 2B are collectively referred to as a plurality of physical machines 2 below. The virtual machine 3A, the virtual machine 3B, and the virtual machine 3C are collectively referred to as a plurality of virtual machines 3 below. Moving routes between the physical machine 2A and the physical machine 2B are collectively referred to as a plurality of moving routes below. The virtual machine 3A, the virtual machine 3B, the virtual machine 3C, the physical machine 2A, and the physical machine 2B are also described below as a virtual machine A, a virtual machine B, a virtual machine C, a physical machine A, and a physical machine B, respectively.

The deployment information 141 is information of each of the physical machines 2 or each of the virtual machines 3, for each unit time included in a time indicated by the estimation time information 133. In a case where a specific virtual machine 3 is disposed in a specific physical machine 2 in a specific unit time, a first value (for example, 1) is set in the deployment information 141, as information corresponding to the specific unit time, the specific virtual machine 3, and the specific physical machine 2. In a case where a specific virtual machine 3 is not disposed in a specific physical machine 2 in a specific unit time, a second value (for example, 0) which is smaller than the first value is set in the deployment information 141, as information corresponding to the specific unit time, the specific virtual machine 3, and the specific physical machine 2.

The status information 142 is information of each of the virtual machines 3 and each of moving routes of the virtual machines 3 between the physical machines 2, for each unit time included in a time indicated by the estimation time information 133. In a case where moving of a specific virtual machine 3 is completed in a specific unit time, the first value is set in the status information 142, as information corresponding to the specific unit time, the specific virtual machine 3, and a moving route for the completed moving. In a case where moving of a specific virtual machine 3 is not completed in a specific unit time, the second value is set in the status information 142, as information corresponding to the specific unit time, the specific virtual machine 3, and a moving route for the moving which has not been completed. Descriptions will be made below on the assumption that the first value is 1, and the second value is 0.

Specific Examples of Deployment Information and Status Information

Next, specific examples of the deployment information 141 and the status information 142 will be described. FIGS. 15A to 17B are diagrams illustrating specific examples of the deployment information 141 and the status information 142. Specifically, FIGS. 15A to 17B are diagram illustrating the specific examples of the deployment information (first variable) 141 and status information (second variable) 142 after the values are calculated by the process of S8. A time point when moving a virtual machine 3 is started is also referred to as a time point 0 below. A time point after a unit time elapses from the time point 0 is also referred to as a time point 1 below. A time point after a unit time elapses from the time point 1 is also referred to as a time point 2 below.

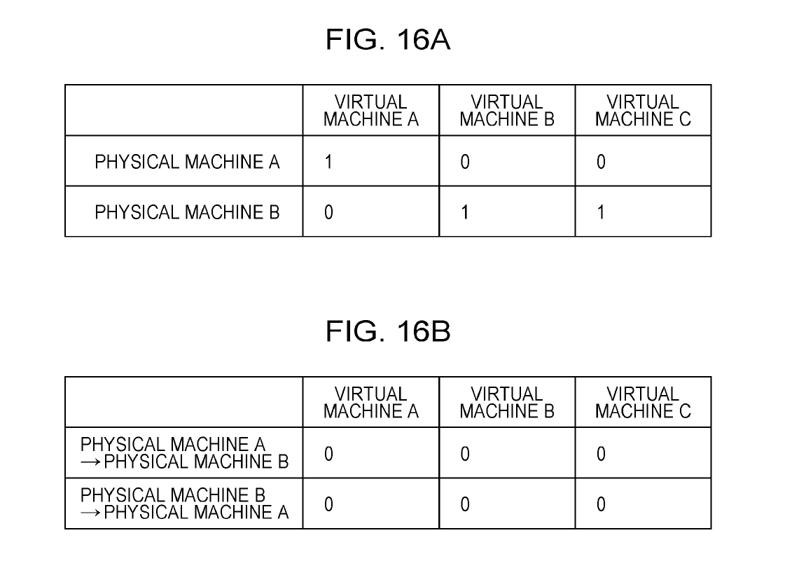

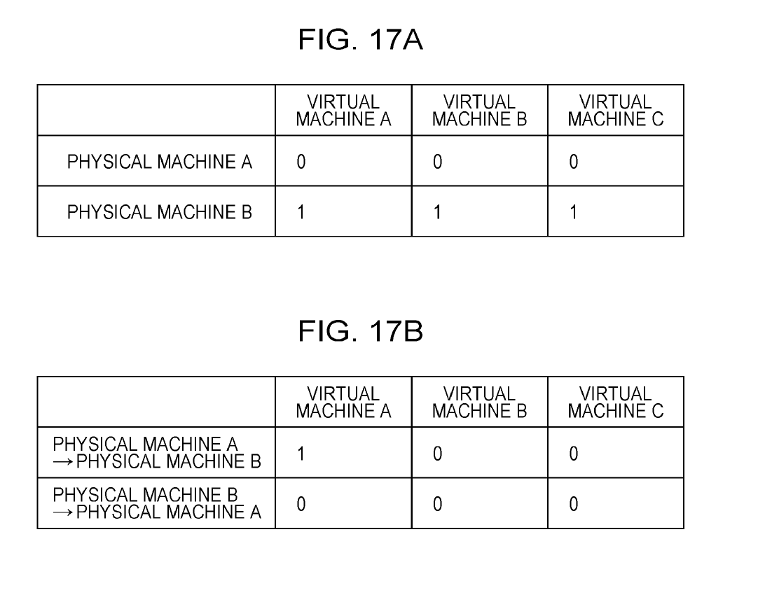

Specifically, FIG. 15A is a diagram illustrating a specific example of the deployment information 141 at the time point 0. FIG. 15B is a diagram illustrating a specific example of the status information 142 at the time point 0. FIG. 16A is a diagram illustrating a specific example of the deployment information 141 at the time point 1. FIG. 16B is a diagram illustrating a specific example of the status information 142 at the time point 1. FIG. 17A is a diagram illustrating a specific example of the deployment information 141 at the time point 2. FIG. 17B is a diagram illustrating a specific example of the status information 142 at the time point 2.

Vertical columns in the deployment information 141 illustrated in FIGS. 15A, 16A, and 17A correspond to the physical machine 2A and the physical machine 2B, respectively. Horizontal columns in the deployment information 141 illustrated in FIGS. 15A, 16A, and 17A correspond to the virtual machine 3A, the virtual machine 3B, and the virtual machine 3C, respectively. Vertical columns in the status information 142 illustrated in FIGS. 15B, 16B, and 17B correspond to a moving route from the physical machine 2A to the physical machine 2B and a moving route from the physical machine 2B to the physical machine 2A, respectively. Horizontal columns in the status information 142 illustrated in FIGS. 15B, 16B, and 17B correspond to the virtual machine 3A, the virtual machine 3B, and the virtual machine 3C, respectively.

More specifically, in the deployment information 141 illustrated in FIG. 15A, “1” is set in the column corresponding to “virtual machine A” and “physical machine A”, the column corresponding to “virtual machine B” and “physical machine B”, and the column corresponding to “virtual machine C” and “physical machine B”. In the deployment information 141 illustrated in FIG. 15A, “0” is set in the column corresponding to “virtual machine A” and “physical machine B”, the column corresponding to “virtual machine B” and “physical machine A”, and the column corresponding to “virtual machine C” and “physical machine A”. That is, the deployment information 141 illustrated in FIG. 15A indicates that the virtual machine 3A is disposed in the physical machine 2A and the virtual machine 3B and the virtual machine 3C are disposed in the physical machine 2B at the time point 0.

In the status information 142 illustrated in FIG. 15B, “0” is set in all columns. That is, the status information 142 illustrated in FIG. 15B indicates that a virtual machine 3 of which moving is completed is not provided at the time point 0.

In the deployment information 141 illustrated in FIG. 16A, “1” is set in the column corresponding to “virtual machine A” and “physical machine A”, the column corresponding to “virtual machine B” and “physical machine B”, and the column corresponding to “virtual machine C” and “physical machine B”. In the deployment information 141 illustrated in FIG. 16A, “0” is set in the column corresponding to “virtual machine A” and “physical machine B”, the column corresponding to “virtual machine B” and “physical machine A”, and the column corresponding to “virtual machine C” and “physical machine A”. That is, the deployment information 141 illustrated in FIGS. 15A and 16A indicates that a virtual machine 3 of which moving is completed is not provided for a period from the time point 0 to the time point 1.

In the status information 142 illustrated in FIG. 16B, “0” is set in all columns. That is, the status information 142 illustrated in FIG. 16B indicates that a virtual machine 3 of which moving is completed is not provided at the time point 1.

In the deployment information 141 illustrated in FIG. 17A, the column corresponding to “virtual machine A” and “physical machine A” is updated from “1” to “0” and the column corresponding to “virtual machine A” and “physical machine B” is updated from “0” to “1”, in comparison to the deployment information 141 illustrated in FIG. 16A. That is, the deployment information 141 illustrated in FIGS. 16A and 17A indicates that the virtual machine 3A has moved from the physical machine 2A to the physical machine 2B for a period from the time point 1 to the time point 2.

In the status information 142 illustrated in FIG. 17B, a column corresponding to “virtual machine A” and “physical machine A physical machine B” is updated from “0” to “1” in comparison to the status information 142 illustrated in FIG. 16B. That is, the status information 142 illustrated in FIG. 17B indicates that moving of the virtual machine 3A disposed in the physical machine 2A to the physical machine 2B is completed at the time point 2.

Specific Example of Total Duration Information

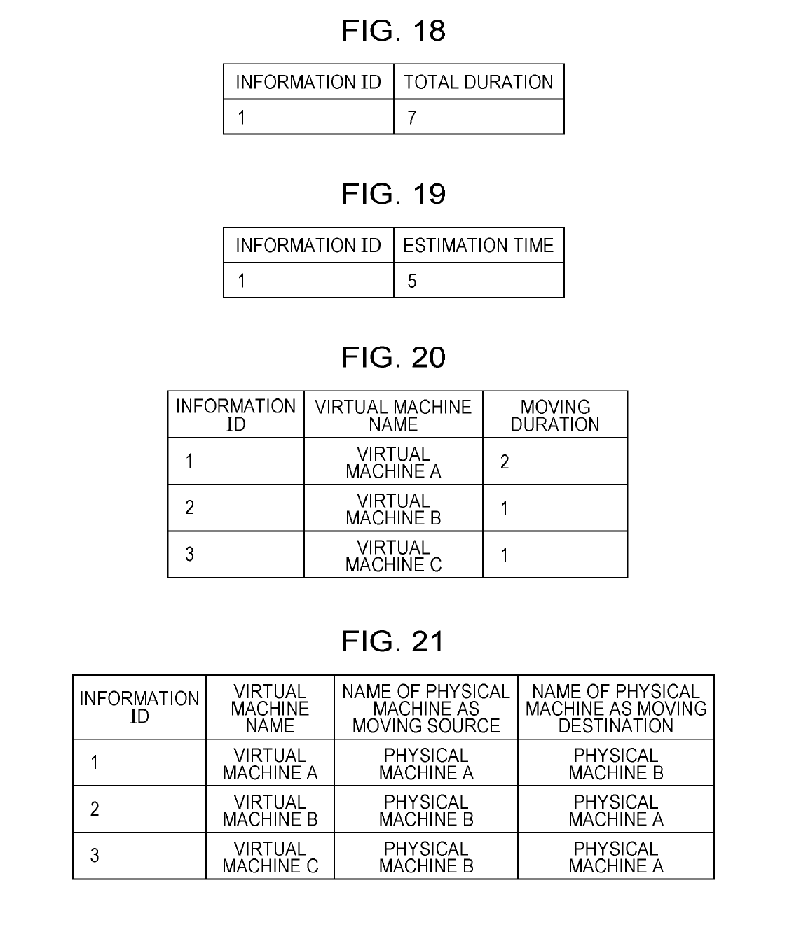

Next, a specific example of the total duration information 143 will be described. In the example illustrated in FIG. 18, total duration information (third variable) 143 after the values are calculated by the process of S8 will be described.

The total duration information 143 illustrated in FIG. 18 includes “information ID” for identifying each piece of information included in the total duration information 143 and “total duration” indicating a time which is taken to move all of the virtual machines 3 between the physical machines 2, as items.

Specifically, in the total duration information 143 illustrated in FIG. 18, “7” is set as “total duration”, in information having “1” set in “information ID”.

Details of Process of S2

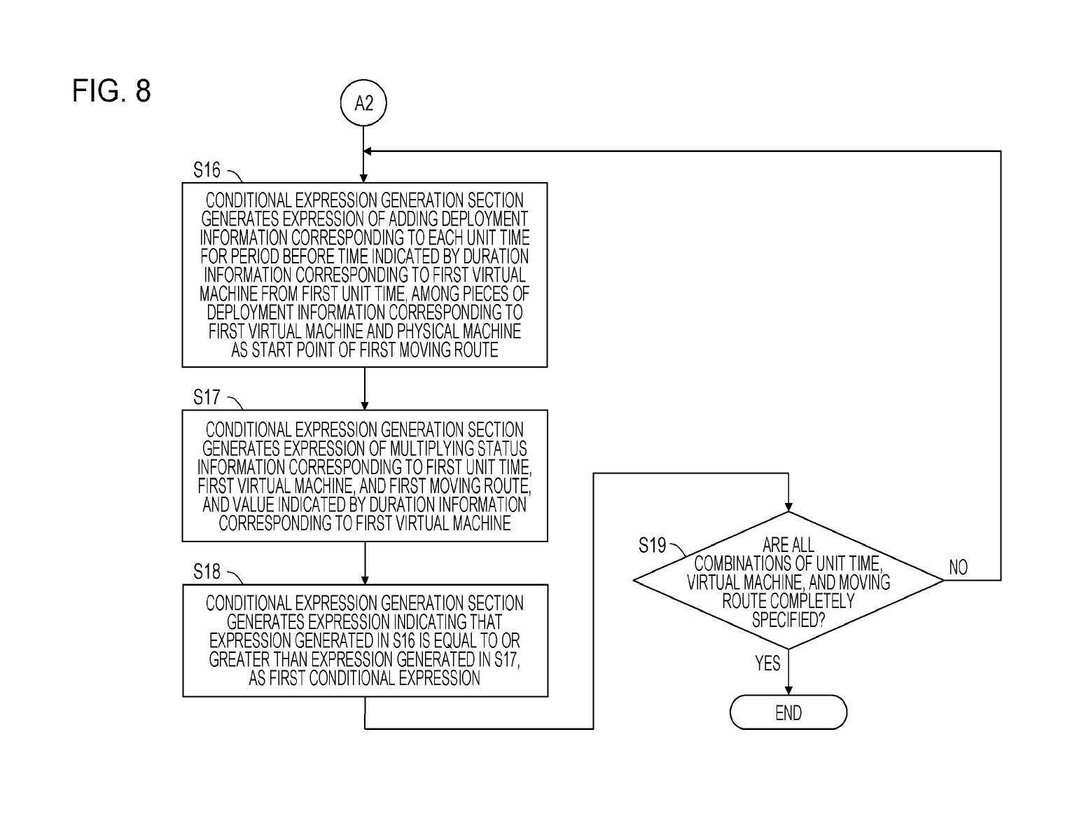

Next, details of the process of S2 illustrated in FIG. 5 will be described. FIGS. 7 and 8 are flowcharts illustrating the details of the process of S2.

The conditional expression generation section 111 specifies deployment information 141 corresponding to a specific unit time (also referred to as a first unit time below), a specific virtual machine 3 (also referred to as a first virtual machine 3 below), and a physical machine 2 which is a start point of a specific moving route (also referred to as a first moving route below), among pieces of deployment information 141 (S11). That is, the conditional expression generation section 111 specifies (extracts) a certain piece of information among pieces of information included in the deployment information 141.

The conditional expression generation section 111 specifies deployment information 141 corresponding to a unit time (also referred to as a second unit time below) which is next to the first unit time, the first virtual machine 3, and a physical machine 2 which is an end point of the first moving route, among pieces of deployment information 141 (S12).

The conditional expression generation section 111 adds the deployment information 141 specified in the process of S12 to the deployment information 141 specified in the process of S11, and thus generates an expression of subtracting the first value (S13). Further, the conditional expression generation section 111 generates an expression indicating that the expression generated in the process of S13 is equal to or smaller than status information 142 corresponding to the second unit time, the first virtual machine 3, and the first moving route, as a first expression (S14).

Then, the conditional expression generation section 111 determines whether or not all combinations of unit times included in a time indicated by the estimation time information 133, virtual machines 3 which move between physical machines 2, and moving routes of the virtual machines 3 between the physical machines 2 are specified in the process of S11 (S15). Specifically, the conditional expression generation section 111 performs the process of S15 with reference to the estimation time information 133 stored in the information storage area 130. A specific example of the process of S15 will be described below.

Specific Example of Estimation Time Information

FIG. 19 is a diagram illustrating a specific example of the estimation time information 133. The estimation time information 133 illustrated in FIG. 19 includes “information ID” for identifying each piece of information included in the estimation time information 133 and “estimation time” indicating an estimation time which is taken to move all of the virtual machines 3 between the physical machines 2, as items.

Specifically, in the estimation time information 133 illustrated in FIG. 19, “5” is set as “estimation time”, in information having “1” set in “information ID”.

Returning to FIG. 7, in a case where it is determined that specifying all of the combinations is not completed in the process of S11 (NO in S15), the conditional expression generation section 111 performs the process of S11 and the subsequent processes for a combination (the process of S11 and the subsequent processes are not performed) of a unit time, a virtual machine 3, and a moving route. In a case where it is determined that specifying all of the combinations is completed in the process of S11 (YES in S15), the conditional expression generation section 111 performs the process of S16 and the subsequent processes.

Specifically, the conditional expression generation section 111 repeats the processes of S11 to S14, and thus generates Expression (1) as a first conditional expression, for example.

Q_{v,p}_{₂}^{m+1}+Q_{v,p}_{₁}^{m}−1≦E_{v,p}_{₁}_{,p}_{₂}^{m+1},∀m,v (1)

In Expression (1), Q indicates the deployment information 141 and E indicates the status information 142. In Expression (1), m indicates the first unit time, and “m+1” indicates the second unit time. v indicates the first virtual machine 3, and p₁ indicates the physical machine 2 which is the start point of the first moving route. p₂ indicates the physical machine 2 which is the end point of the first moving route. Thus, a first term on the left-hand side of Expression (1) indicates deployment information 141 corresponding to the second unit time, the first virtual machine 3, and the physical machine 2 which is the end point of the first moving route. A second term on the left-hand side of Expression (1) indicates deployment information 141 corresponding to the first unit time, the first virtual machine 3, and the physical machine 2 which is the start point of the first moving route. The right-hand side of Expression (1) indicates status information 142 corresponding to the second unit time, the first virtual machine 3, and the first moving route.

Returning to FIG. 7, in a case where it is determined that specifying all of the combinations is completed in the process of S11 (YES in S15), as illustrated in FIG. 8, the conditional expression generation section 111 specifies deployment information 141 corresponding to the first virtual machine 3 and the physical machine 2 which is the start point of the first moving route. The conditional expression generation section 111 generates an expression of adding deployment information 141 which corresponds to each unit time for a time before a time indicated by the duration information 132 corresponding to the first virtual machine 3 from the first unit time, among specified pieces of deployment information 141 (S16).

Then, the conditional expression generation section 111 generates an expression of multiplying the status information 142 which corresponds to the first unit time, the first virtual machine 3, and the first moving route, by a value indicated by the duration information 132 corresponding to the first virtual machine 3 (S17). Specifically, the conditional expression generation section 111 performs the process of S17 with reference to the duration information 132 stored in the information storage area 130. A specific example of the duration information 132 will be described below.

Specific Example of Duration Information

FIG. 20 is a diagram illustrating the specific example of the duration information 132. The duration information 132 illustrated in FIG. 20 includes “information ID” for identifying each piece of information included in the duration information 132, “virtual machine name” for identifying each of the virtual machines 3, and “moving duration” indicating a time which is taken to cause each of the virtual machines 3 to move between the physical machines 2, as items.

Specifically, in the duration information 132 illustrated in FIG. 20, “virtual machine A” is set as “virtual machine name” and “2” is set as “moving duration”, in information having “1” set in “information ID”. Descriptions of other pieces of information illustrated in FIG. 20 will be not repeated.

Returning to FIG. 8, the conditional expression generation section 111 generates an expression indicating that the expression generated in the process of S16 is equal to or larger than the expression generated in the process of S17, as the first conditional expression (S18).

Then, the conditional expression generation section 111 determines whether or not all combinations of unit times included in a time indicated by the estimation time information 133, virtual machines 3 which move between physical machines 2, and moving routes of the virtual machines 3 between the physical machines 2 are specified in the process of S16 (S19). In a case where it is determined that specifying all of the combinations is not completed in the process of S16 (NO in S19), the conditional expression generation section 111 performs the process of S16 and the subsequent processes for a combination (the process of S16 and the subsequent processes are not performed) of a unit time, a virtual machine 3, and a moving route. In a case where it is determined that specifying all of the combinations is completed in the process of S16 (YES in S19), the conditional expression generation section 111 ends the process of S2.

Specifically, the conditional expression generation section 111 repeats the processes of S16 to S18, and thus generates Expression (2) as the first conditional expression, for example.

Σⱼ₌₁^{k}^{ᵥ}Q_{v,p}_{₁}^{m-j}≧kᵥE_{v,p}_{₁}_{,p}_{₂}^{m},∀m,v (2)

In Expression (2), Q indicates the deployment information 141 and E indicates the status information 142. In Expression (2), m indicates the first unit time, and v indicates the first virtual machine 3. p₁ indicates the physical machine 2 which is the start point of the first moving route, and p₂ indicates the physical machine 2 which is the end point of the first moving route. kᵥ indicates duration information 132 corresponding to the first virtual machine 3.

That is, the conditional expression generation section 111 generates an expression obtained by associating the deployment information 141 and the status information 142 with each other, as the first conditional expression.

Details of Process of S3

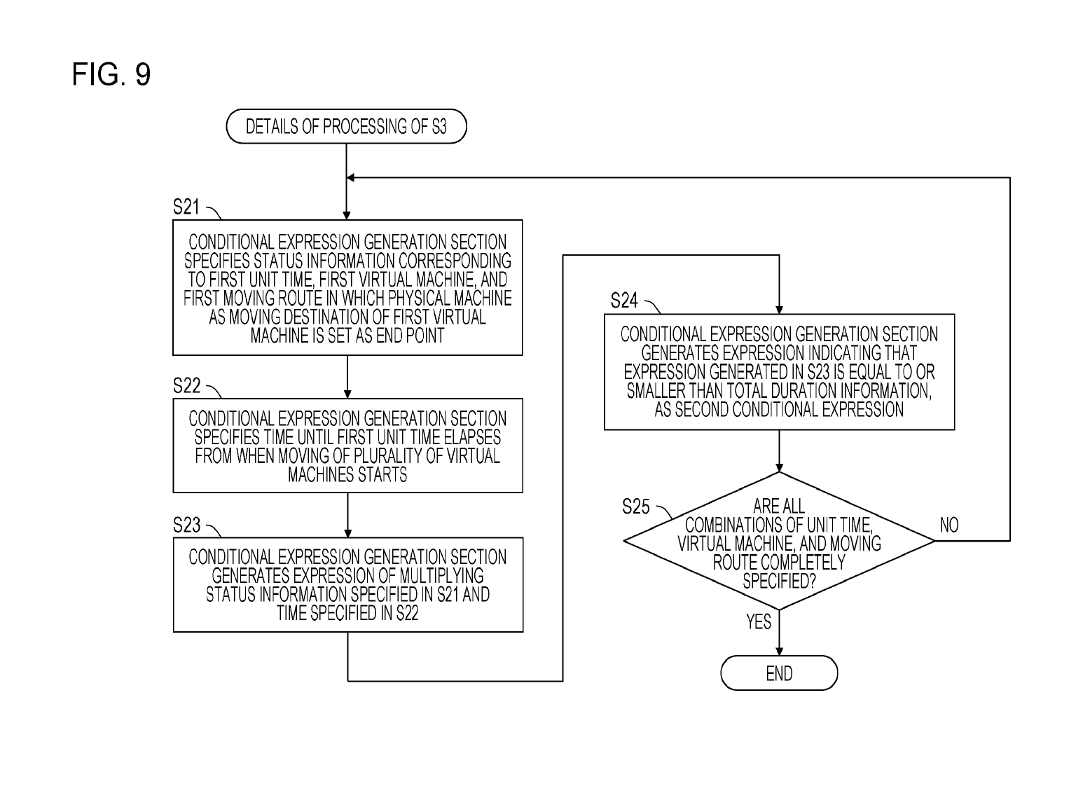

Next, details of the process of S3 illustrated in FIG. 5 will be described. FIG. 9 is a flowchart illustrating the details of the process of S3.

The conditional expression generation section 111 specifies status information 142 corresponding to the first unit time, the first virtual machine 3, and the first moving route on which the physical machine 2 as the moving destination of the first virtual machine 3 is set as the end point (S21). Specifically, the conditional expression generation section 111 performs the process of S21 with reference to the movement information 131 stored in the information storage area 130. A specific example of the movement information 131 will be described below.

Specific Example of Movement Information

FIG. 21 is a diagram illustrating the specific example of the movement information 131. The movement information 131 illustrated in FIG. 21 includes “information ID” for identifying each piece of information included in the movement information 131, and “virtual machine name” for identifying each of the virtual machines 3, as items. The movement information 131 illustrated in FIG. 21 includes “name of physical machine as moving source” for identifying a physical machine 2 as a moving source of each of the virtual machines 3, and “name of physical machine as moving destination” for identifying a physical machine 2 as a moving destination of each of the virtual machines 3.

Specifically, in the movement information 131 illustrated in FIG. 21, “virtual machine A” is set as “virtual machine name”, “physical machine A” is set as “name of physical machine as moving source”, and “physical machine B” is set as “name of physical machine as moving destination”, in information having “1” set in “information ID”. Descriptions of other pieces of information illustrated in FIG. 21 will be not repeated.

Returning to FIG. 9, the conditional expression generation section 111 specifies a time from when moving the plurality of virtual machines 3 starts until the first unit time elapses (S22).

The conditional expression generation section 111 calculates an expression of multiplying the status information 142 specified in the process of S21, by the time specified in the process of S22 (S23). The conditional expression generation section 111 generates an expression indicating that the expression generated in the process of S23 is equal to or smaller than the total duration information 143, as the second conditional expression (S24).

Then, the conditional expression generation section 111 determines whether or not all combinations of unit times included in a time indicated by the estimation time information 133, virtual machines 3 which move between physical machines 2, and physical machines 2 to which the virtual machines 3 move respectively are specified in the process of S21 (S25). In a case where it is determined that specifying all of the combinations is not completed in the process of S21 (NO in S25), the conditional expression generation section 111 performs the process of S21 and the subsequent processes for a combination (the process of S21 and the subsequent processes are not performed) of a unit time, a virtual machine 3, and a moving route. In a case where it is determined that specifying all of the combinations is completed in the process of S21 (YES in S25), the conditional expression generation section 111 ends the process of S3.

Specifically, the conditional expression generation section 111 repeats the processes of S21 to S24, and thus generates Expression (3) as a second conditional expression, for example.

mE_{v,p,g(v)}^{m}≦SP,∀m,v,p (3)

In Expression (3), E indicates the status information 142, and SP indicates the total duration information 143. In Expression (3), m indicates the first unit time, and v indicates the first virtual machine 3. g(v) indicates a physical machine 2 as a moving destination of the first virtual machine (physical machine 2 which is the end point of the first moving route). p indicates the physical machine 2 which is the start point of the first moving route.

That is, the conditional expression generation section 111 generates an expression indicating that moving of each of the virtual machines 3 is completed ahead of the time indicated by the total duration information 143 (time when moving all of the virtual machines 3 is completed), as the second conditional expression.

Details of Process of S4

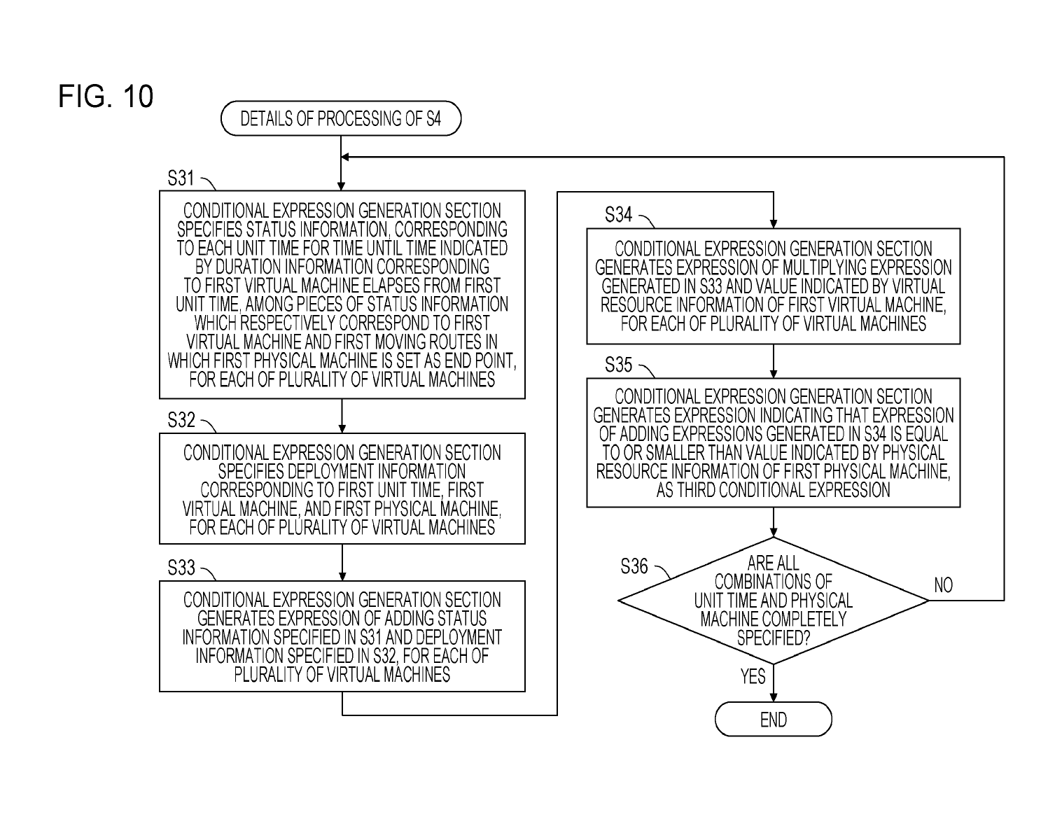

Next, details of the process of S4 illustrated in FIG. 5 will be described. FIG. 10 is a flowchart illustrating the details of the process of S4.

The conditional expression generation section 111 specifies status information 142 corresponding to the first virtual machine 3 and the first moving route on which the first physical machine 2 is set as the end point. The conditional expression generation section 111 specifies status information 142 corresponding to each unit time for a time until a time indicated by the duration information 132 corresponding to the first virtual machine 3 elapses from the first unit time, among the specified pieces of status information 142. The conditional expression generation section 111 performs the specifying for each of the plurality of virtual machines 3 (S31).

The conditional expression generation section 111 specifies deployment information 141 corresponding to the first unit time, the first virtual machine 3, and the first physical machine 2, for each of the plurality of virtual machines 3 (S32). The conditional expression generation section 111 calculates an expression of adding the status information 142 specified in the process of S31 and the deployment information 141 specified in the process of S32, for each of the plurality of virtual machines 3 (S33).

Then, the conditional expression generation section 111 generates an expression of multiplying the expression generated in the process of S33, by a value indicated by the virtual resource information 135 of the first virtual machine 3, for each of the plurality of virtual machines 3 (S34). The conditional expression generation section 111 generates an expression indicating that a value obtained by adding each expression generated in the process of S34 is equal to or more than a value indicated by the physical resource information 134 of the first physical machine 2, as the third conditional expression (S35). Specifically, the conditional expression generation section 111 performs the processes of S34 and S35 with reference to the physical resource information 134 and the virtual resource information 135 which have been stored in the information storage area 130. Specific examples of the physical resource information 134 and the virtual resource information 135 will be described below.

Specific Examples of Physical Resource Information and Virtual Resource Information

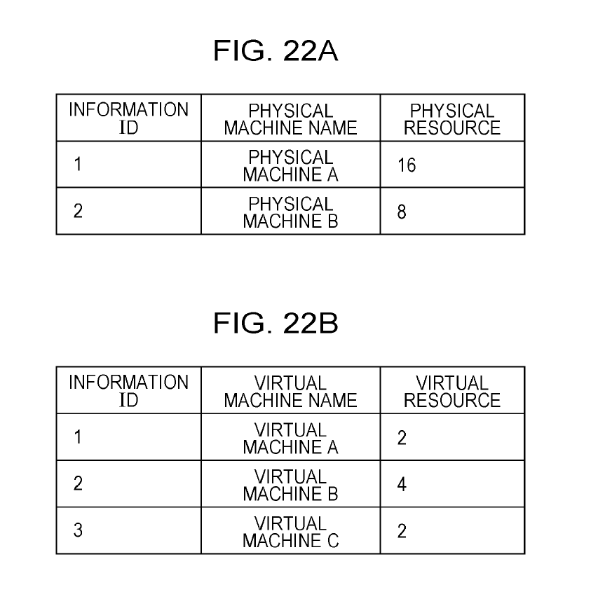

FIGS. 22A and 22B are diagrams illustrating the specific examples of the physical resource information 134 and the virtual resource information 135. FIG. 22A is a diagram illustrating the specific example of the physical resource information 134. FIG. 22B is a diagram illustrating the specific example of the virtual resource information 135.

The physical resource information 134 illustrated in FIG. 22A includes “information ID” for identifying each piece of information included in the physical resource information 134, “physical machine name” for identifying each of the physical machines 2, and “physical resource” indicating the capacity of available resources of each of the physical machines 2, as items.

Specifically, in the physical resource information 134 illustrated in FIG. 22A, “physical machine A” is set as “physical machine name”, and “16” is set as “physical resource”, in information having “1” set in “information ID”. Descriptions of other pieces of information illustrated in FIG. 22A will be not repeated.

The virtual resource information 135 illustrated in FIG. 22B includes “information ID” for identifying each piece of information included in the virtual resource information 135, “virtual machine name” for identifying each of the virtual machines 3, and “virtual resource” indicating the capacity of use resources of each of the virtual machines 3, as items.

Specifically, in the virtual resource information 135 illustrated in FIG. 22B, “virtual machine A” is set as “virtual machine name”, and “2” is set as “virtual resource”, in information having “1” set in “information ID”. Descriptions of other pieces of information illustrated in FIG. 22B will be not repeated.

Returning to FIG. 10, the conditional expression generation section 111 determines whether or not all combinations of unit times included in a time indicated by the estimation time information 133 and physical machines 2 are specified in the process of S31 (S36). In a case where it is determined that specifying all of the combinations is not completed in the process of S31 (NO in S36), the conditional expression generation section 111 performs the process of S31 and the subsequent processes for a combination (the process of S31 and the subsequent processes are not performed) of a unit time and a physical machine 2. In a case where it is determined that specifying all of the combinations is completed in the process of S31 (YES in S36), the conditional expression generation section 111 ends the process of S4.

Specifically, the conditional expression generation section 111 repeats the processes of S31 to S35, and thus generates Expression (4) as a third conditional expression, for example.

ΣᵥCPUᵥ{Q_{v,p}^{m}+Σⱼ₌₁^{k}^{ᵥ}ΣₕE_{v,h,p}^{m+j}}≦CPUₚ,∀p,m (4)

In Expression (4), Q indicates the deployment information 141 and E indicates the status information 142. In Expression (4), m indicates the first unit time, and v indicates the first virtual machine 3. p indicates the first physical machine 2, and h indicates a physical machine which is a start point of a moving route on which a first physical machine is set as an end point. kᵥ indicates duration information 132 corresponding to the first virtual machine 3. In Expression (4), CPUₚ indicates the physical resource information 134, and CPUᵥ indicates the virtual resource information 135.

That is, the conditional expression generation section 111 generates an expression indicating that the remaining resources obtained by using the running virtual machine 3 are provided in the physical machine 2 as the moving destination of each of the virtual machines 3, as the third conditional expression.

The conditional expression generation section 111 may generate Expression (4) for each of plural kinds of resources (for example, CPU, memory, and the like).

Details of Process of S5

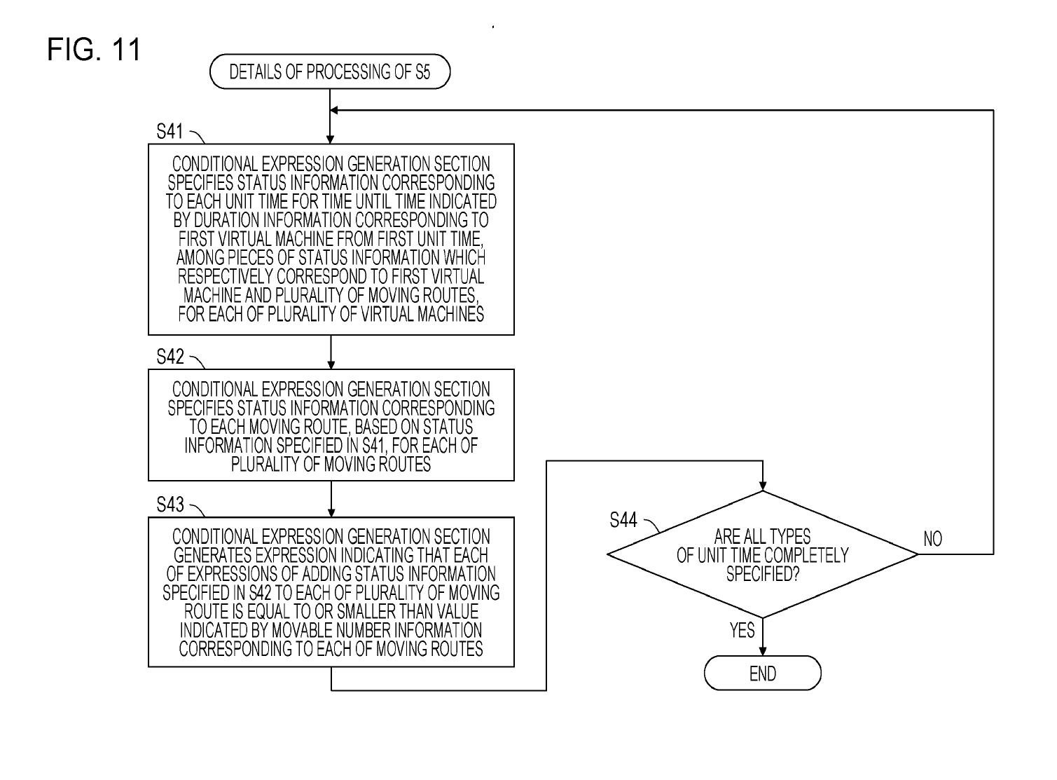

Next, details of the process of S5 illustrated in FIG. 5 will be described. FIG. 11 is a flowchart illustrating the details of the process of S5.

The conditional expression generation section 111 specifies status information 142 corresponding to each unit time for a time until a time indicated by the duration information 132 corresponding to the first virtual machine 3 elapses from the first unit time, among pieces of status information 142 which correspond to the first virtual machine 3 and a plurality of moving routes. The conditional expression generation section 111 performs the specifying for each of the plurality of virtual machines 3 (S41).

The conditional expression generation section 111 specifies status information 142 corresponding to each of the moving routes for each of the plurality of moving routes, based on the status information 142 which has been specified in the process of S41 (S42).

In a case where a network device such as a router device, which can converge moving routes is provided on a plurality of moving routes, the conditional expression generation section 111 specifies a plurality of networks divided by the network device, in the process of S42. In this case, the conditional expression generation section 111 specifies status information 142 for each of the plurality of specified networks. A specific example in a case where the network device is provided on the plurality of moving routes will be described below.

Specific Example in Case where Network Device is Provided on Plurality of Moving Routes

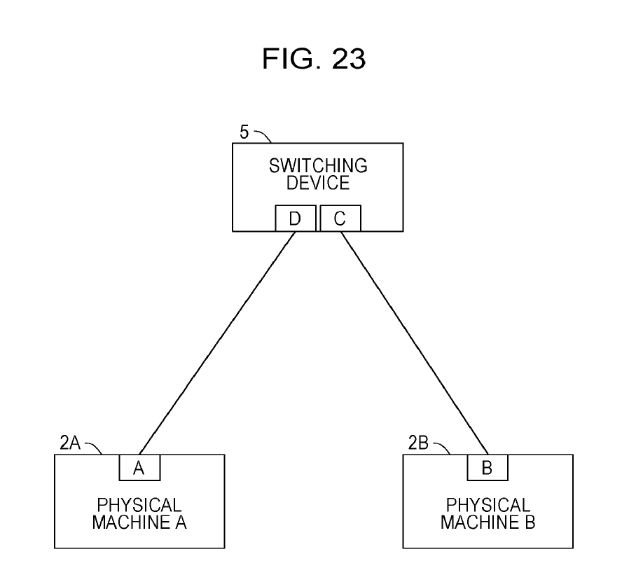

FIG. 23 is a diagram illustrating the specific example in a case where a network device is provided on a moving route. Specifically, FIG. 23 is a diagram illustrating a case where a switching device 5 is provided on a moving route between the physical machine 2A and the physical machine 2B.

In the example illustrated in FIG. 23, the physical machine 2A and the physical machine 2B include a port A and a port B, respectively. In the example illustrated in FIG. 23, the switching device 5 includes a port C and a port D.

As illustrated in FIG. 23, in a case where the switching device 5 is provided on the moving route between the physical machine 2A and the physical machine 2B, a network (simply also referred to as a network A below) from the port A of the physical machine 2A toward the switching device 5 and a network (simply also referred to as a network C below) from the port C of the switching device 5 toward the physical machine 2B are provided between the physical machine 2A and the physical machine 2B. In this case, a network (simply also referred to as a network B below) from the port B of the physical machine 2B toward the switching device 5, and a network (simply also referred to as a network D below) from the port D of the switching device 5 toward the physical machine 2A are provided between the physical machine 2A and the physical machine 2B. A specific example of the network information 136 in a case where the switching device 5 is provided on the moving route between the physical machine 2A and the physical machine 2B will be described below.

Specific Example of Network Information

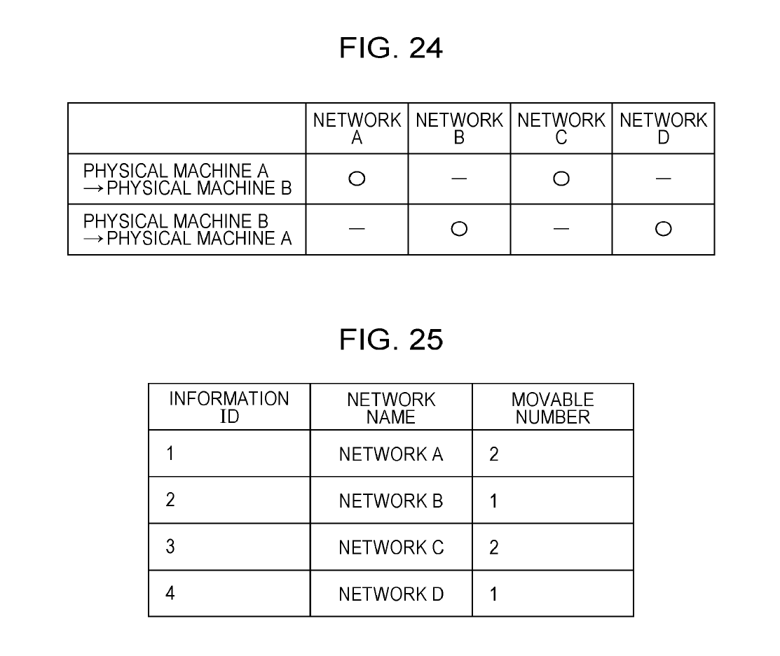

FIG. 24 is a diagram illustrating the specific example of the network information 136. The network information 136 is information in which each of the moving routes and each network correspond to each other.

Vertical columns in the network information 136 illustrated in FIG. 24 correspond to “physical machine A→physical machine B” and “physical machine B→physical machine A” which are used for identifying moving routes, respectively. Horizontal columns in the network information 136 illustrated in FIG. 24 correspond to “network A”, “network B”, “network C”, and “network D” which are used for identifying networks, respectively.

Specifically, in the network information 136 illustrated in FIG. 24, “O” indicating that information is provided is set in a column corresponding to “physical machine A→physical machine B” and “network A”, and a column corresponding to “physical machine A→physical machine B” and “network C”. In the network information 136 illustrated in FIG. 24, “-” indicating that information is not provided is set in a column corresponding to “physical machine A→physical machine B” and “network B”, and a column corresponding to “physical machine A→physical machine B” and “network D”.

That is, the network information 136 illustrated in FIG. 24 indicates that the network A from the port A of the physical machine 2A toward the switching device 5 and the network C from the port C of the switching device 5 toward the physical machine 2B are included in a moving route from the physical machine A to the physical machine B. Descriptions of other pieces of information illustrated in FIG. 24 will be not repeated.

Thus, in this case, the conditional expression generation section 111 specifies status information 142 for each of the network A, the network B, the network C, and the network D in the process of S42.

Returning to FIG. 11, the conditional expression generation section 111 generates an expression indicating that each expression of adding the status information 142 specified in the process of S42 for each of the plurality of moving routes is equal to or smaller than a value indicated by the movable number information 137 corresponding to each of the moving routes, as the fourth conditional expression (S43). In a case where the network device is provided on the plurality of moving routes, the conditional expression generation section 111 generates an expression indicating that each expression of adding the status information 142 specified in the process of S42 for each of a plurality of networks is equal to or smaller than a value indicated by the movable number information 137 corresponding to each of the networks, as the fourth conditional expression. Specifically, the conditional expression generation section 111 performs the process of S43 with reference to the movable number information 137 stored in the information storage area 130. A specific example of the movable number information 137 will be described below.

Specific Example of Movable Number Information

FIG. 25 is a diagram illustrating the specific example of the movable number information 137. The movable number information 137 illustrated in FIG. 25 includes “information ID” for identifying each piece of information included in the movable number information 137, “network name” for identifying each of the networks, and “movable number” which is the number of virtual machines 3 which are movable in parallel with each other in the networks, as items.

Specifically, in the movable number information 137 illustrated in FIG. 25, “network A” is set as “network name”, and “2” is set as “movable number”, in information having “1” set in “information ID”. Descriptions of other pieces of information illustrated in FIG. 25 will be not repeated.

Returning to FIG. 11, the conditional expression generation section 111 determines whether or not all unit times included in a time indicated by the estimation time information 133 are specified in the process of S41 (S44). In a case where it is determined that specifying all of the unit time is not completed in the process of S41 (NO in S44), the conditional expression generation section 111 performs the process of S41 and the subsequent processes for a unit time on which the process of S41 and the subsequent processes are not performed. In a case where it is determined that specifying all of the unit times is completed in the process of S41 (YES in S44), the conditional expression generation section 111 ends the process of S5.

Specifically, the conditional expression generation section 111 repeats the processes of S41 to S43, and thus generates Expression (5) as a fourth conditional expression, for example.

ΣᵥΣⱼ₌₁^{k}^{ᵥ}Σₚ_{₁}_{,p}_{₂}E_{v,p}_{₁}_{,p}_{₂}^{m+j}≦migₗ,∀l,m (5)

In Expression (5), E indicates the status information 142, and l indicates each network. migₗ indicates movable number information 137 of each network. In Expression (5), m indicates the first unit time, and v indicates the first virtual machine 3. p₁ indicates a physical machine 2 which is a start point of each of the moving routes, and p₂ indicates a physical machine 2 which is an end point of each of the moving routes. kᵥ indicates duration information 132 corresponding to the first virtual machine 3.

That is, the conditional expression generation section 111 generates an expression indicating that a moving route (network) on which the number of virtual machines 3 which move in parallel with each other is more than the movable number is not provided, as the fourth conditional expression.

Details of Process of S6

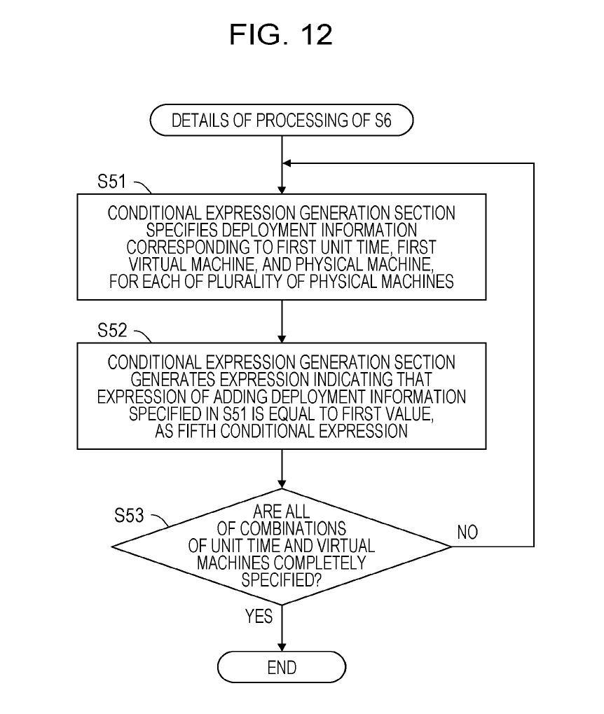

Next, details of the process of S6 illustrated in FIG. 5 will be described. FIG. 12 is a flowchart illustrating the details of the process of S6.

The conditional expression generation section 111 specifies deployment information 141 corresponding to the first unit time, the first virtual machine 3, and the first physical machine, for each of the plurality of physical machines 2 (S51). The conditional expression generation section 111 generates an expression indicating that an expression of adding the deployment information 141 specified in the process of S51 is equal to the first value, as the fifth conditional expression (S52).

Then, the conditional expression generation section 111 determines whether or not all combinations of unit times included in a time indicated by the estimation time information 133 and virtual machines 3 are specified in the process of S51 (S53). In a case where it is determined that specifying all of the combinations is not completed in the process of S51 (NO in S53), the conditional expression generation section 111 performs the process of S51 and the subsequent processes for a combination (the process of S51 and the subsequent processes are not performed) of a unit time and a virtual machine 3. In a case where it is determined that specifying all of the combinations is completed in the process of S51 (YES in S53), the conditional expression generation section 111 ends the process of S6.

Specifically, the conditional expression generation section 111 repeats the processes of S51 and S52, and thus generates Expression (6) as a fifth conditional expression, for example.

ΣₚQ_{v,p}^{m}=1,∀v,m (6)

In Expression (6), Q indicates deployment information 141. m indicates the first unit time, v indicates the first virtual machine 3, and p indicates each of the physical machines 2.

That is, the conditional expression generation section 111 generates an expression indicating that each of the virtual machines 3 is disposed in any of the plurality of physical machines 2 in each unit time, as the fifth conditional expression.

Details of Process of S7

Next, details of the process of S7 illustrated in FIG. 5 will be described. FIG. 13 is a flowchart illustrating the details of the process of S7.

The conditional expression generation section 111 specifies deployment information 141 corresponding to the first virtual machine 3 and the physical machine 2 as the moving source of the first virtual machine 3. The conditional expression generation section 111 performs the specifying for each unit time for a period from when moving the first virtual machine 3 starts until a time indicated by the duration information 132 corresponding to the first virtual machine 3 elapses (S61). The conditional expression generation section 111 generates an expression indicating that an expression of adding the deployment information 141 specified in the process of S61 is equal to a value indicated by the duration information 132 corresponding to the first virtual machine 3, as the sixth conditional expression (S62).

The conditional expression generation section 111 generates an expression indicating that deployment information 141 which corresponds to a time indicated by the estimation time information 133, the first virtual machine 3, and the physical machine 2 as the moving destination of the first virtual machine 3 is equal to the first value, as the sixth conditional expression (S63).

Then, the conditional expression generation section 111 determines whether or not all of the virtual machines 3 are specified in the process of S61 (S64). In a case where it is determined that specifying all of the virtual machines 3 is not completed in the process of S61 (NO in S64), the conditional expression generation section 111 performs the process of S61 and the subsequent processes for a virtual machine 3 on which the process of S61 and the subsequent processes are not performed. In a case where it is determined that specifying all of the virtual machines 3 is completed in the process of S61 (YES in S64), the conditional expression generation section 111 ends the process of S7.

Specifically, the conditional expression generation section 111 repeats the processes of S61 and S62, and thus generates Expression (7) as a sixth conditional expression, for example.

Σⱼ₌₀^{k}^{ᵥ}⁻¹Q_{v,p}_{ᵢ}^{j}=kᵥ,∀v (7)

In Expression (7), Q indicates deployment information 141. v indicates the first virtual machine 3, and pᵢ indicates the physical machine 2 as the moving source of the first virtual machine 3. kᵥ indicates the duration information 132 corresponding to the first virtual machine 3.

That is, in a case where each of the virtual machines 3 moves from the physical machine 2 as the moving source, the conditional expression generation section 111 generates an expression indicating that each of the virtual machines 3 is disposed in the physical machine 2 as the moving source until moving thereof is completed, as the sixth conditional expression.

The conditional expression generation section 111 repeats the process of S63, and thus generates Expression (8) as the sixth conditional expression, for example.

Q_{v,p}_{_{f}}^{m}^{_{f}}=1,∀v (8)

In Expression (8), Q indicates deployment information 141. v indicates the first virtual machine 3, and p_{f} indicates the physical machine 2 as the moving destination of the first virtual machine 3. m_{f} indicates estimation time information 133.

That is, the conditional expression generation section 111 generates an expression indicating that each of the virtual machines 3 is disposed in the physical machine 2 as the moving destination in the time indicated by the estimation time information 133, as the sixth conditional expression.

Then, the conditional expression generation section 111 stores the expressions generated in the processes of S2 to S7, in the information storage area 130, as a portion (also referred to as constraint conditional expression information 138a below) of the generated-expression information 138. A specific example of the constraint conditional expression information 138a will be described below.

Specific Example of Constraint Conditional Expression Information

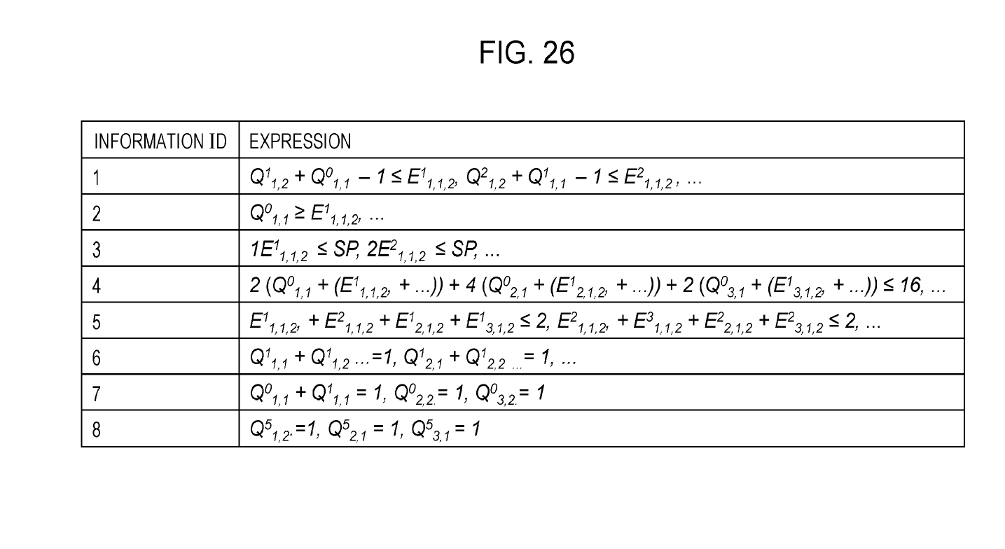

FIG. 26 is a diagram illustrating the specific example of the constraint conditional expression information 138a. The constraint conditional expression information 138a illustrated in FIG. 26 includes “information ID” for identifying each expression included in the constraint conditional expression information 138a, and “expression” in which an expression is set, as items.

Specifically, in the constraint conditional expression information 138a illustrated in FIG. 26, “Q¹_{1,2}+Q⁰_{1,1}−1≦E¹_{1,1,2}, Q²_{1,2}+Q¹_{1,1}−1≦E²_{1,1,2}, . . . ” is set as “expression”, in information having “information ID” of “1”. Descriptions of other pieces of information illustrated in FIG. 26 will be not repeated.

Details of Process of S8

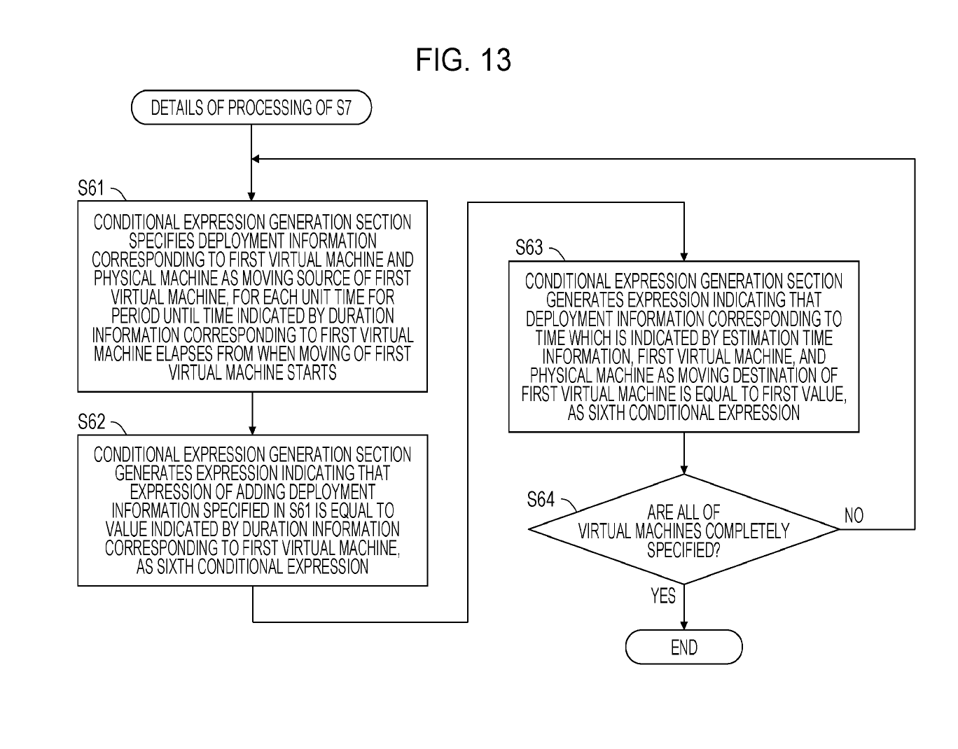

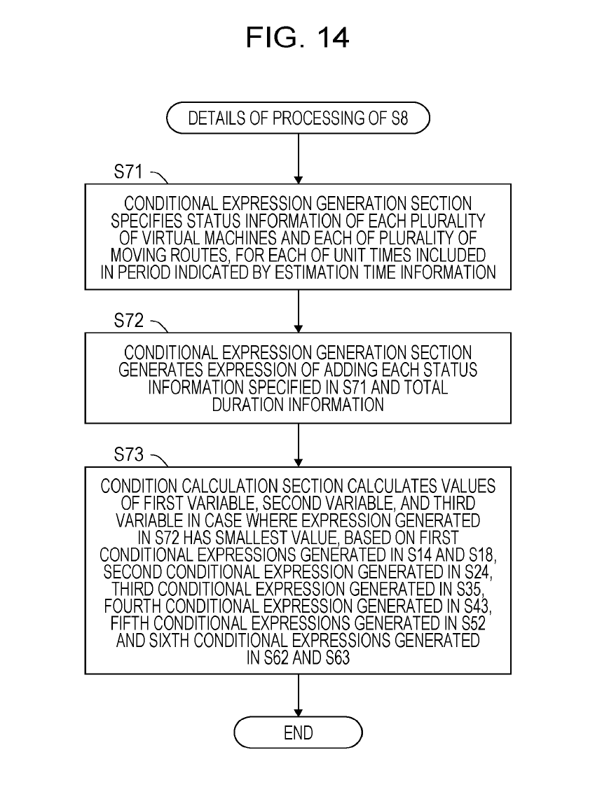

Next, details of the process of S8 illustrated in FIG. 5 will be described. FIG. 14 is a flowchart illustrating the details of the process of S8.

The conditional expression generation section 111 specifies each piece of status information 142 of each of the plurality of virtual machines 3 and each of the plurality of moving routes, for each unit time included in the time indicated by the estimation time information 133 (S71). The conditional expression generation section 111 generates an expression of adding each piece of the status information 142 specified in the process of S71 and the total duration information 143 (S72).

Specifically, the conditional expression generation section 111 performs the process of S72, and thus generates Expression (9), for example.

minimize SP+δΣₘΣᵥΣₚ_{₁}_{,p}_{₂}E_{v,p}_{₁}_{,p}_{₂}^{m} (9)

In Expression (9), E indicates the status information 142, and m indicates each of the unit times. v indicates each of the virtual machines 3, and p₁ indicates a physical machine 2 which is a start point of each of the moving routes. p₂ indicates a physical machine 2 which is an end point of each of the moving routes. δ indicates a coefficient (for example, sufficiently small coefficient).

That is, Expression (1) is an expression which is completed even when the status information 142 on the right-hand side thereof is 0 or 1. Thus, in a case where the condition in which the total duration information 143 has the smallest value is calculated from Expression (1) to Expression (8), the condition calculation section 112 may calculate a condition in which moving of a virtual machine 3, which is not to be performed is performed.

The conditional expression generation section 111 generates an expression of adding each piece of the status information 142 specified in the process of S71 to the total duration information 143, in the process of S72. As will be described later, the condition calculation section 112 calculates a condition in which the expression generated in the process of S72 has the smallest value.

Thus, the condition calculation section 112 can calculate a condition in which the summation (that is, total number of times of the virtual machines 3 moving) of pieces of the status information 142 specified in the process of S71 has the smallest value in addition to the total duration information 143. Thus, the condition calculation section 112 can calculate a condition in which moving of a virtual machine 3, which is not to be performed is not performed.

δ which is a coefficient is multiplied by a second term in Expression (9). Thus, the condition calculation section 112 can calculate a condition in which both of the total duration information 143 and the summation of the pieces of the status information 142 specified in the process of S71 have the smallest values.

The condition calculation section 112 stores the expression generated in the process of S72, in the information storage area 130, as a portion of the generated-expression information 138 (also referred to as objective functional expression information 138b below). A specific example of the objective functional expression information 138b will be described below.

Specific Example of Objective Functional Expression Information

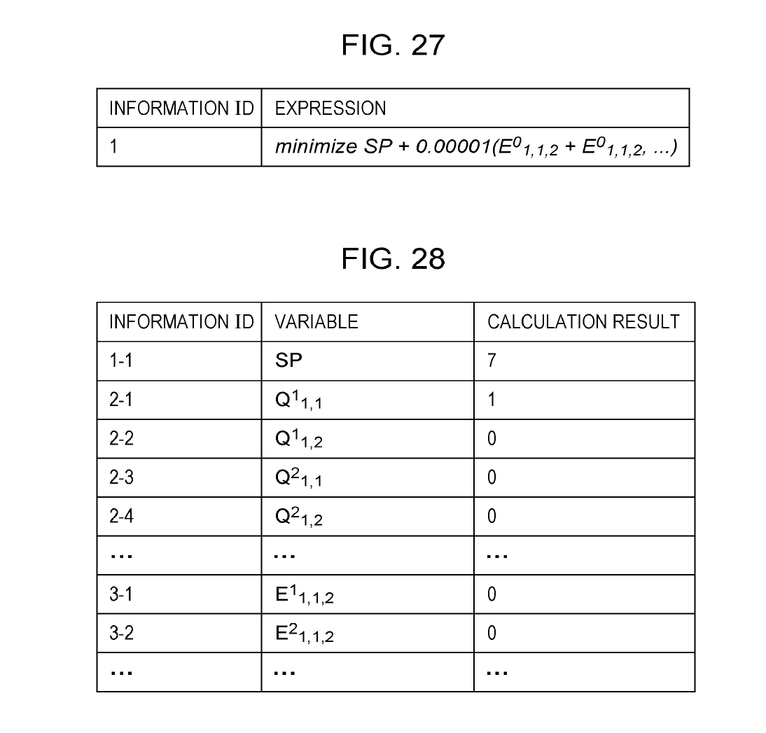

FIG. 27 is a diagram illustrating the specific example of the objective functional expression information 138b. The objective functional expression information 138b illustrated in FIG. 27 includes “information ID” for identifying each expression included in the objective functional expression information 138b, and “expression” in which an expression is set, as items.

Specifically, in the objective functional expression information 138b illustrated in FIG. 27, “minimize SP+0.00001(E⁰_{1,1,2}+E⁰_{1,1,2}, . . . )” is set as “expression”, in information having “information ID” of “1”.

Returning to FIG. 14, the condition calculation section 112 acquires the first conditional expression generated in the processes of S14 and S18, the second conditional expression generated in the process of S24, the third conditional expression generated in the process of S35, the fourth conditional expression generated in the process of S43, the fifth conditional expression generated in the process of S52, and the sixth conditional expression generated in the process of S62 and S63. Specifically, the condition calculation section 112 acquires each of the expressions, with reference to the constraint conditional expression information 138a stored in the information storage area 130, for example. The condition calculation section 112 acquires the expression generated in the process of S72, with reference to the objective functional expression information 138b stored in the information storage area 130. The condition calculation section 112 calculates values of the deployment information 141, the status information 142, and the total duration information 143 in a case where the expression generated in the process of S72 has the smallest value, based on the first conditional expression, the second conditional expression, the third conditional expression, the fourth conditional expression, the fifth conditional expression, and the sixth conditional expression which have been acquired (S73).

The condition calculation section 112 stores a result (also referred to as result information below) calculated, for example, by the process of S73, in the information storage area 130. A specific example of the result information will be described below.

Specific Example of Result Information

FIG. 28 is a diagram illustrating the specific example of the result information. The result information illustrated in FIG. 28 includes “information ID” for identifying each expression included in the result information, “variable” indicating each variable, and “calculation result” which is a result obtained by calculating a value corresponding to each variable, as items.

Specifically, in the result information illustrated in FIG. 28, “SP” is set in “variable” and “7” is set in “calculation result” of information having “information ID” of “1-1”. In the result information illustrated in FIG. 28, “Q¹_{1,1}” is set in “variable” and “1” is set in “calculation result” of information having “information ID” of “2-1”. In the result information illustrated in FIG. 28, “E¹_{1,1,2}” is set in “variable” and “0” is set in “calculation result” of information having “information ID” of “3-1”. Descriptions of other pieces of information illustrated in FIG. 28 will be not repeated.

Thus, the moving instruction section 113 refers to the result information stored in the information storage area 130 and the like, and thus can specify a movement order and a moving start time of each of the virtual machines 3. Thus, the information processing apparatus 1 can perform relocation of virtual machines 3 in accordance with the optimum deployment of the virtual machines 3, for a period as short as possible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A moving control method which is performed by a computer, the moving control method comprising:
generating a first conditional expression for indicating a relationship between a first variable and a second variable, based on duration information, estimation time information, the first variable, and the second variable, the duration information for indicating time taken to move each of a plurality of virtual machines which move between a plurality of physical machines, the estimation time information for indicating estimation time taken to move the plurality of virtual machines, the first variable for indicating a physical machine on which each of the plurality of virtual machines is disposed, and the second variable for indicating a movement status of each of the plurality of virtual machines;
generating a second conditional expression for indicating a relationship between the second variable and a third variable, based on the estimation time information, the second variable, and a third variable for indicating time taken to move the plurality of virtual machines;
generating a third conditional expression for indicating a condition of resource information of a virtual machine moving to a physical machine as a moving destination, based on movement information, the estimation time information, resource information of each of the plurality of physical machines, resource information of each of the plurality of virtual machines, the first variable, and the second variable, the movement information for indicating physical machines as a moving source and a moving destination of each of the plurality of virtual machines;
generating a fourth conditional expression for indicating a condition of movable number information corresponding to a moving route when each of the plurality of virtual machines moves, based on the movement information, the duration information, the estimation time information, the movable number information, and the second variable, the movable number information for indicating the number of virtual machines which are movable in parallel to each of the plurality of moving routes between the plurality of physical machines;
generating a fifth conditional expression for indicating that each of the plurality of virtual machines is disposed on any of the plurality of physical machines, based on the movement information, the estimation time information, and the first variable;
generating a sixth conditional expression for indicating that each of the plurality of virtual machines is disposed on a physical machine as the moving source during a period from when moving from the physical machine as the moving source is started until moving from the physical machine as the moving source is completed, and that each of the plurality of virtual machines is disposed on a physical machine as the moving destination in a period indicated by the estimation time information, based on the movement information, the duration information, the estimation time information, and the first variable;
calculating values of the first variable, the second variable, and the third variable in a case where the third variable is smallest, based on the first conditional expression, the second conditional expression, the third conditional expression, the fourth conditional expression, the fifth conditional expression, and the sixth conditional expression; and
performing an instruction to move each of the plurality of virtual machines, based on the values of the first variable, the second variable, and the third variable in a case where the third variable is smallest, regarding moving of the plurality of virtual machines between the plurality of physical machines.

2. A non-transitory, computer-readable recording medium having stored therein a program for causing a computer to execute a process, the process comprising:
generating a first conditional expression for indicating a relationship between a first variable and a second variable, based on duration information, estimation time information, the first variable, and the second variable, the duration information for indicating time taken to move each of a plurality of virtual machines which move between a plurality of physical machines, the estimation time information for indicating estimation time taken to move the plurality of virtual machines, the first variable for indicating a physical machine on which each of the plurality of virtual machines is disposed, and the second variable for indicating a movement status of each of the plurality of virtual machines;
generating a second conditional expression for indicating a relationship between the second variable and a third variable, based on the estimation time information, the second variable, and a third variable for indicating time taken to move the plurality of virtual machines;
generating a third conditional expression for indicating a condition of resource information of a virtual machine moving to a physical machine as a moving destination, based on movement information, the estimation time information, resource information of each of the plurality of physical machines, resource information of each of the plurality of virtual machines, the first variable, and the second variable, the movement information for indicating physical machines as a moving source and a moving destination of each of the plurality of virtual machines;
generating a fourth conditional expression for indicating a condition of movable number information corresponding to a moving route when each of the plurality of virtual machines moves, based on the movement information, the duration information, the estimation time information, the movable number information, and the second variable, the movable number information for indicating the number of virtual machines which are movable in parallel to each of the plurality of moving routes between the plurality of physical machines;
generating a fifth conditional expression for indicating that each of the plurality of virtual machines is disposed on any of the plurality of physical machines, based on the movement information, the estimation time information, and the first variable;
generating a sixth conditional expression for indicating that each of the plurality of virtual machines is disposed on a physical machine as the moving source during a period from when moving from the physical machine as the moving source is started until moving from the physical machine as the moving source is completed, and that each of the plurality of virtual machines is disposed on a physical machine as the moving destination in a period indicated by the estimation time information, based on the movement information, the duration information, the estimation time information, and the first variable;
calculating values of the first variable, the second variable, and the third variable in a case where the third variable is smallest, based on the first conditional expression, the second conditional expression, the third conditional expression, the fourth conditional expression, the fifth conditional expression, and the sixth conditional expression; and
performing an instruction to move each of the plurality of virtual machines, based on the values of the first variable, the second variable, and the third variable in a case where the third variable is smallest, regarding moving of the plurality of virtual machines between the plurality of physical machines.

3. The non-transitory, computer-readable recording medium according to claim 2,
wherein the first variable is a variable for each unit time included in the period indicated by the estimation time information, for each of the plurality of virtual machines, for each of the plurality of physical machines, and is a variable which causes a first value to be set in information corresponding to a specific unit time, a specific virtual machine, and a specific physical machine in a case where the specific virtual machine is disposed on the specific physical machine in the specific unit time, and is a variable which causes a second value to be set in information corresponding to the specific unit time, the specific virtual machine, and the specific physical machine in a case where the specific virtual machine is not disposed on the specific physical machine in the specific unit time, and
the second variable is a variable for each unit time included in the period indicated by the estimation time information, for each of the plurality of virtual machines, for each of the plurality of moving routes, and is a variable which causes the first value to be set in information corresponding to the specific unit time, the specific virtual machine, and a moving route on which moving is completed in a case where moving the specific virtual machine is completed in the specific unit time, and is a variable which causes the second value to be set in information corresponding to the specific unit time, the specific virtual machine, and a moving route on which moving is not completed, in a case where moving the specific virtual machine is not completed in the specific unit time.

4. The non-transitory, computer-readable recording medium according to claim 3,
wherein, in the generating of the first conditional expression,
an expression for indicating that an expression of adding the first variable which corresponds to second unit time which is next to first unit time, a first virtual machine, a physical machine which is an end point of a first moving route to the first variable corresponding to the first unit time, the first virtual machine, and a physical machine which is a start point of the first moving route, and subtracting the first value is equal to or smaller than the second variable corresponding to the second unit time, the first virtual machine, and the first moving route, is generated as the first conditional expression, and
an expression for indicating that an expression of adding the first variable corresponding to each unit time for a period ahead of a time indicated by the duration information corresponding to the first virtual machine from the first unit time, among first variables corresponding to the first virtual machine and a physical machine which is a start point of the first moving route, is equal to or larger than an expression of multiplying the second variable corresponding to the first unit time, the first virtual machine, and the first moving route by a value indicated by the duration information corresponding to the first virtual machine, is generated as the first conditional expression.

5. The non-transitory, computer-readable recording medium according to claim 3,
wherein, in the generating of the second conditional expression, an expression for indicating an expression of multiplying the second variable corresponding to a first unit time, a first virtual machine, and a first moving route in which a physical machine as the moving destination of the first virtual machine is set as an end point, by a time from when moving the plurality of virtual machines is started until the first unit time elapses is equal to or smaller than the third variable is generated as the second conditional expression.

6. The non-transitory, computer-readable recording medium according to claim 3,
wherein, in the generating of the third conditional expression,
an expression of adding the second variable corresponding to each unit time for a period from the first unit time until a time indicated by the duration information corresponding to the first virtual machine elapses among second variables corresponding to a first virtual machine and a first moving route in which the first physical machine is set as an end point, and the first variable corresponding to the first unit time, the first virtual machine, and the first physical machine, and an expression of multiplying a value indicated by the resource information of the first virtual machine are generated for each of the plurality of virtual machines, and
an expression for indicating that an expression of adding each generated expression is equal to or smaller than the value indicated by the resource information of the first physical machine is generated as the third conditional expression.

7. The non-transitory, computer-readable recording medium according to claim 3,
wherein, in the generating of the fourth conditional expression,
the second variable corresponding to each unit time for a period from the first unit time until a time indicated by the duration information corresponding to the first virtual machine elapses among second variables corresponding to a first virtual machine and any of the plurality of moving routes is specified, for each of the plurality of virtual machines,
the second variable corresponding to each of the moving routes is specified for each of the plurality of moving routes, based on the specified second variable, and
an expression for indicating that each expression of adding the specified second variable for each of the plurality of moving routes is equal to or smaller than a value indicated by the movable number information corresponding to each of the moving routes is generated as the fourth conditional expression.

8. The non-transitory, computer-readable recording medium according to claim 7,
wherein, in the specifying of the second variable for each of the plurality of moving routes, in a case where a network device is disposed on any of the plurality of moving routes, the second variable is specified for each of a plurality of networks divided by the network device, and
in the generating of the fourth conditional expression, an expression for indicating that each expression of adding the second variable for each of the plurality of networks is equal to or smaller than the value indicated by the movable number information corresponding to each of the networks is generated.

9. The non-transitory, computer-readable recording medium according to claim 3,
wherein, in the generating of the fifth conditional expression, the first variable corresponding to a first unit time, a first virtual machine, and a first physical machine is specified for each of the plurality of physical machines, and
an expression indicating that an expression of adding the specified first variable is equal to the first value is generated as the fifth conditional expression.

10. The non-transitory, computer-readable recording medium according to claim 3,
wherein, in the generating of the sixth conditional expression,
the first variable corresponding to a first virtual machine and a physical machine as the moving source of the first virtual machine is specified for each unit time for a period from when moving the first virtual machine is started until a time indicated by the duration information corresponding to the first virtual machine elapses,
an expression indicating that an expression of adding the specified first variable has a value indicated by the duration information corresponding to the first virtual machine is generated as the sixth conditional expression, and
an expression indicating that the first variable corresponding to a first unit time, the first virtual machine, and a physical machine as the moving destination of the first virtual machine is equal to the first value is generated as the sixth conditional expression.

11. The non-transitory, computer-readable recording medium according to claim 3,
wherein, in the calculating of the values in a case where the third variable is smallest, values of the first variable, the second variable, and the third variable in a case where an expression of adding each of second variables for each unit time included in a time indicated by the estimation time information, for each of the plurality of virtual machines, and for each of the plurality of moving routes, and the third variable is smallest are calculated.

12. The non-transitory, computer-readable recording medium according to claim 2,
wherein, in the calculating of the values in a case where the third variable is the smallest, a computer is caused to execute a program of calculating a condition which causes the third variable to be smallest, by using the first conditional expression, the second conditional expression, the third conditional expression, the fourth conditional expression, the fifth conditional expression, and the sixth conditional expression as an input, so as to calculate the values of the first variable, the second variable, and the third variable in the case where the third variable is smallest.

13. A moving control apparatus comprising:
a memory; and
a processor coupled to the memory and the processor configured to
generate a first conditional expression for indicating a relationship between a first variable and a second variable, based on duration information, estimation time information, the first variable, and the second variable, the duration information indicating time taken to move each of a plurality of virtual machines which move between a plurality of physical machines, the estimation time information for indicating estimation time taken to move the plurality of virtual machines, the first variable indicating a physical machine on which each of the plurality of virtual machines is disposed, and the second variable indicating a movement status of each of the plurality of virtual machines,
generate a second conditional expression indicating a relationship between the second variable and a third variable, based on the estimation time information, the second variable, and a third variable indicating time taken to move the plurality of virtual machines,
generate a third conditional expression indicating a condition of resource information of a virtual machine moving to a physical machine as a moving destination, based on movement information, the estimation time information, resource information of each of the plurality of physical machines, resource information of each of the plurality of virtual machines, the first variable, and the second variable, the movement information indicating physical machines as a moving source and a moving destination of each of the plurality of virtual machines,
generate a fourth conditional expression indicating a condition of movable number information corresponding to a moving route when each of the plurality of virtual machines moves, based on the movement information, the duration information, the estimation time information, the movable number information, and the second variable, the movable number information indicating the number of virtual machines which are movable in parallel to each of the plurality of moving routes between the plurality of physical machines,
generate a fifth conditional expression indicating that each of the plurality of virtual machines is disposed on any of the plurality of physical machines, based on the movement information, the estimation time information, and the first variable,
generate a sixth conditional expression indicating that each of the plurality of virtual machines is disposed on a physical machine as the moving source during a period from when moving from the physical machine as the moving source is started until moving from the physical machine as the moving source is completed, and that each of the plurality of virtual machines is disposed on a physical machine as the moving destination in a period indicated by the estimation time information, based on the movement information, the duration information, the estimation time information, and the first variable,
calculate values of the first variable, the second variable, and the third variable in a case where the third variable is smallest, based on the first conditional expression, the second conditional expression, the third conditional expression, the fourth conditional expression, the fifth conditional expression, and the sixth conditional expression, and
perform an instruction to move each of the plurality of virtual machines, based on the values of the first variable, the second variable, and the third variable in a case where the third variable is smallest, regarding moving of the plurality of virtual machines between the plurality of physical machines.
